(19) United States
(12) Patent Application Publication
(10) Pub. No.: US 2025/0066978 A1
(43) Pub. Date: Feb. 27, 2025

(54) METHOD OF PROVIDING GARMENT INFORMATION AND GARMENT TREATMENT DEVICE USING THE METHOD

(71) Applicant: SAMSUNG ELECTRONICS CO., LTD., Suwon-si (KR)

(72) Inventors: Myungwoo LEE, Suwon-si (KR); Byeongcheol YOON, Suwon-si (KR); Younghak KONG, Suwon-si (KR); Hyelim PARK, Suwon-si (KR); Soohyun SUNG, Suwon-si (KR); Sori JEON, Suwon-si (KR); Chihong CHO, Suwon-si (KR)

(21) Appl. No.: 18/780,336

(22) Filed: Jul. 22, 2024

Related U.S. Application Data
(63) Continuation of application No. PCT/KR2024/007348, filed on May 29, 2024.

(30) Foreign Application Priority Data
Aug. 25, 2023 (KR) 10-2023-0112283
Jan. 4, 2024 (KR) 10-2024-0001736

(51) Int. Cl. D06F 34/28; D06F 34/14; D06F 103/06; D06F 105/58

(52) U.S. Cl. CPC D06F 34/28; D06F 34/14; D06F 2103/06; D06F 2105/58

(57) ABSTRACT

Provided are a garment treatment device and method for guiding a user through treatment of a garment. The garment treatment device obtains garment information of a plurality of garments accommodated in the garment treatment device, through a tag reader, determine, based on the obtained garment information, whether there is a garment that needs to be separated from other garments among the plurality of garments, based on determining that there is the garment that needs to be separated from the other garments, output, through output components, guide information for guiding a user through separating the garment that needs to be separated from the other garments, along with identification information of the garment that needs to be separated, and control garment treatment components according to a user input received in response to the guide information, to wash or dry the other garments with or without the garment that needs to be separated.

### CROSS-REFERENCE TO RELATED APPLICATIONS

This application is a Bypass Continuation application of International Application No. PCT/KR2024/007348, filed May 29, 2024, which claims priority to Korea Application No. 10-2023-0112283, filed Aug. 25, 2023, and Korean Application No. 10-2024-0001736, filed Jan. 4, 2024, both filed in the Korean intellectual property office, the disclosures of which are incorporated by reference herein in their entirety.

### BACKGROUND

### 1. Field

The disclosure relates to a garment treatment device for providing garment information, and a method of controlling the garment treatment device. The disclosure relates to a garment treatment device for providing garment information about washing or drying, a method of controlling the garment treatment device, and a computer-readable recording medium having stored therein a computer program for performing the method of controlling the garment treatment device.

### 2. Description of Related Art

Washing machines may include a tub for accommodating wash water, and a drum that is rotatably installed inside the tub to accommodate laundry therein.

In typical washing machines (i.e., top loaders), laundry in a drum is washed by rotating a circular pulsator. In drum washing machines (i.e., front loaders), laundry is washed by a force generated as the laundry rises to the top of a drum and then falls to hit water or other laundry.

A dryer dries laundry by using heat to evaporate the moisture in the laundry. A heater dryer may dry laundry by using a heater to heat the air in the laundry and rotating a hot-air fan to circulate the heated air in the laundry. In addition, a heat pump dryer may dry laundry by using a low-temperature dehumidification method for removing moisture from the laundry by circulating a refrigerant.

A garment management device may perform garment management, such as drying a garment, removing dust or odors on a garment, or removing wrinkles from a garment.

The garment management device may include a heat exchanger for supplying hot air to a management chamber where a garment is stored in order to dry the garment, and may include a steam generator for performing refresh functions such as removing wrinkles from a garment, deodorizing, or removing static electricity.

### SUMMARY

An aspect of an embodiment of the disclosure may provide a garment treatment device for guiding a user through treatment of a garment. The garment treatment device may include garment treatment components, a tag reader, output components, at least one memory storing one or more instructions, and at least one processor. In addition, the at least one processor may be configured to obtain garment information of a plurality of garments accommodated in the garment treatment device, through the tag reader. In addition, the at least one processor may be configured to determine whether there is a garment that needs to be separated from the other garments among the plurality of garments, based on the obtained garment information. In addition, based on determining that there is a garment that needs to be separated from the other garments, the at least one processor may be configured to output, through the output components, guide information for guiding the user through separating the garment that needs to be separated from the other garments, along with identification information of the garment that needs to be separated. In addition, the at least one processor may be configured to control the garment treatment components to wash or dry the other garments with or without the garment that needs to be separated according to a user input received in response to the guide information.

An aspect of an embodiment of the disclosure may provide a method of controlling a garment treatment device for guiding a user through treatment of a garment. The method of controlling the garment treatment device may include obtaining garment information of a plurality of garments accommodated in the garment treatment device, through a tag reader. The method of controlling the garment treatment device may include determining whether there is a garment that needs to be separated from the other garments among the plurality of garments, based on the obtained garment information. The method of controlling the garment treatment device may include, based on determining that there is a garment that needs to be separated from other garments, outputting guide information for guiding the user through separating the garment that needs to be separated from the other garments, along with identification information of the garment that needs to be separated. The method of controlling the garment treatment device may include washing or drying the other garments with or without the garment that needs to be separated, according to a user input received in response to the guide information.

An aspect of an embodiment of the disclosure may provide a computer-readable recording medium having recorded thereon a program for causing a computer to perform a method of controlling a garment treatment device for guiding a user through treatment of a garment.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a method, performed by a garment treatment device, of providing garment information about washing or drying, according to an embodiment of the disclosure.

FIG. 2 illustrates a block diagram of a garment treatment device according to an embodiment of the disclosure.

FIG. 3 is a flowchart of a method, performed by a garment treatment device, of guiding a user through separating a garment, according to an embodiment of the disclosure.

FIG. 4 illustrates a method, performed by a garment treatment device, of storing garment information through a user interface, according to an embodiment of the disclosure.

FIG. 5 illustrates a method, performed by a garment treatment device, of storing garment information through a user device, according to an embodiment of the disclosure.

FIG. 6 illustrates a method, performed by a garment treatment device, of obtaining garment information stored in a garment server, according to an embodiment of the disclosure.

FIG. 7 illustrates a flowchart of a method, performed by a garment treatment device, of obtaining garment information from a user device through a server, according to an embodiment of the disclosure.

FIG. 8 illustrates a method, performed by a garment treatment device, of obtaining garment information from a user device through a server, according to an embodiment of the disclosure.

FIG. 9 illustrates a method, performed by a user device, of obtaining garment information by using a camera, according to an embodiment of the disclosure.

FIG. 10 illustrates a method, performed by a garment treatment device, of guiding a user through separating a garment depending on whether the garment is machine-dryable, according to an embodiment of the disclosure.

FIG. 11 illustrates a method, performed by a garment treatment device, of providing information about a garment that may stain other garments, according to an embodiment of the disclosure.

FIG. 12 illustrates a method, performed by a garment treatment device, of classifying a plurality of garments in a drum into a plurality of groups according to washing methods, according to an embodiment of the disclosure.

FIG. 13 is a flowchart of a method, performed by a garment treatment device, of moving a garment that needs to be separated to a position where the garment may be easily separated, according to an embodiment of the disclosure.

FIG. 14 illustrates a method, performed by a garment treatment device, of rotating a drum to move the position of a garment that needs to be separated, according to an embodiment of the disclosure.

FIG. 15 is a flowchart of a method, performed by a garment treatment device, of changing garment information by learning a user's selection, according to an embodiment of the disclosure.

FIG. 16 is a flowchart of a method, performed by a garment treatment device, of providing a notification for a garment for which a notification is set, according to an embodiment of the disclosure.

FIG. 17 illustrates a method, performed by a garment treatment device, of providing a notification for a garment for which a notification is set, according to an embodiment of the disclosure.

FIG. 18 illustrates a method, performed by a garment treatment device, of outputting a separate-wash notification according to a garment category selected by a user, according to an embodiment of the disclosure.

FIG. 19 illustrates a block diagram of a garment treatment device according to an embodiment of the disclosure.

### DETAILED DESCRIPTION

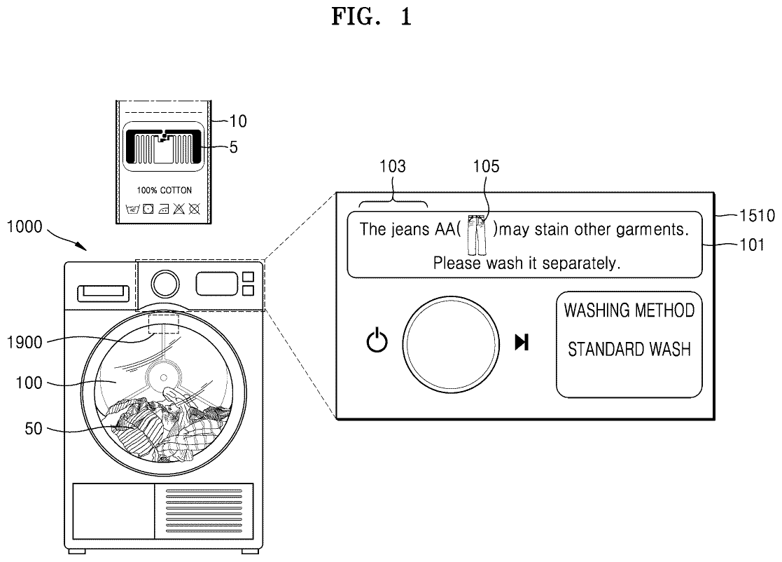

FIGS. 1 through 19, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

As used herein, the expression “at least one of a, b, or c” may indicate only a, only b, only c, both a and b, both a and c, both b and c, all of a, b, and c, or variations thereof.

Hereinafter, an embodiment of the disclosure will be described in detail with reference to the accompanying drawings to enable those of skill in the art to perform the disclosure without any difficulty. The disclosure may, however, be embodied in many different forms and should not be construed as being limited to an embodiment set forth herein. In addition, in order to clearly describe the disclosure, portions that are not relevant to the description will be omitted, and similar reference numerals are assigned to similar elements throughout the present specification.

Although the terms used herein are generic terms, which are currently widely used and are selected by taking into consideration functions thereof, the meanings of the terms may vary according to intentions of those of ordinary skill in the art, legal precedents, or the advent of new technology. Thus, the terms should be defined not by simple appellations thereof but based on the meanings thereof and the context of descriptions throughout the disclosure.

In addition, terms such as ‘first’ or ‘second’ may be used to describe various elements, but the elements should not be limited by the terms. These terms are only used to distinguish one element from another element.

In addition, terms used herein are for describing a particular embodiment of the disclosure, and are not intended to limit the scope of the disclosure. The singular expression also includes the plural meaning as long as it is not inconsistent with the context. In addition, throughout the present specification, when a part is referred to as being “connected to” another part, it may be “directly connected to” the other part or be “electrically connected to” the other part through an intervening element. In addition, when an element is referred to as “including” a component, the element may additionally include other components rather than excluding other components as long as there is no particular opposing recitation.

As used herein, a phrase “in an embodiment” does not necessarily indicate the same embodiment.

An embodiment of the disclosure provides a garment treatment device for recognizing a tag of a garment and providing garment information of the recognized tag, and a method of controlling the garment treatment device.

An embodiment of the disclosure provides a garment treatment device for guiding a user through a washing method or a drying method, and a method of controlling the garment treatment device.

An embodiment of the disclosure provides a garment treatment device for providing guide information about a garment to be washed separately or dried separately, and a method of controlling the garment treatment device.

An embodiment of the disclosure provides a garment treatment device for obtaining garment information about a garment, and a method of controlling the garment treatment device.

FIG. 1 illustrates a method, performed by a garment treatment device 1000, of providing garment information about washing or drying, according to an embodiment of the disclosure.

Referring to FIG. 1, the garment treatment device 1000 may output information about a garment that needs to be separated among laundry 50 loaded into a drum 100.

The garment treatment device 1000 may obtain tag information from a tag 10 attached to a garment, through a tag reader 1900. The laundry 50 may include at least one garment with a tag attached thereto.

The tag reader 1900 may include, but is not limited to, a radio-frequency identification (RFID) reader, a near-field communication (NFC) reader, a quick response (QR) code reader, or a barcode reader. The tag reader 1900 may be provided inside the garment treatment device 1000 to detect a garment in the drum. In addition, the tag reader 1900 may be provided on a front surface or an upper surface of the garment treatment device 1000.

The tag 10 attached to the garment may include at least one of an RFID tag 5, an NFC tag, a QR code tag, or a barcode tag, but is not limited thereto. Tag information obtained from a tag may include garment information in addition to a tag identifier (ID). For example, the tag information may include garment information such as a product number, type, color, size, or serial number of the garment, but is not limited thereto.

A tag attached to a garment may include a unique tag ID. In addition, a tag attached to a garment may not include a separate tag ID. In this case, the garment treatment device 1000 may store unique information of the garment in the tag information, as a tag ID. For example, the garment treatment device 1000 may store the serial number of the garment in the tag information, as a tag ID.

According to an embodiment of the disclosure, the garment treatment device 1000 may directly obtain, from the tag 10, garment information stored in or written on the tag 10 of the garment.

In correspondence to the tag ID, the garment treatment device 1000 may store not only the garment information obtained from the tag but also at least one of garment information obtained from a server or garment information input by a user. Accordingly, in correspondence to the tag ID, the garment treatment device 1000 may store at least one of a product number, type, color, size, serial number, name, manufacturer, wearing season, time of manufacture, degree of staining, washing method, drying method, or care instructions of the garment, but the disclosure is not limited thereto.

According to an embodiment of the disclosure, the garment treatment device 1000 may obtain a tag ID from the tag 10 of the garment, and obtain garment information pre-stored in the garment treatment device 1000 in correspondence to the obtained tag ID.

According to an embodiment of the disclosure, the garment treatment device 1000 may display garment information when a tag of a garment is recognized. For example, as a garment approaches the tag reader, a tag of the garment may enter a recognition area of the tag reader. When the tag of the garment is recognized, the garment treatment device 1000 may display pre-stored garment information in correspondence to tag information or a tag ID of the recognized garment. As tags of a plurality of garments are recognized, the garment treatment device 1000 may sequentially display pieces of tag information or pieces of garment information of the plurality of recognized garments one by one, or may display the pieces of information as a garment list.

Accordingly, the user may confirm garment information of a garment being put into the garment treatment device or a garment accommodated in the garment treatment device. In addition, the garment treatment device 1000 may provide garment information about a garment to be washed, dried, or managed, such that the user may be provided with a method of washing, drying, or managing the garment, without a separate user input.

According to an embodiment of the disclosure, based on the obtained garment information, the garment treatment device 1000 may determine whether there is a garment that needs to be separated from the other garments among a plurality of garments in the drum 100. For example, in a case in which the garment treatment device 1000 is a washing machine, based on information about degrees of staining among the garment information, the garment treatment device 1000 may determine a garment that may stain surrounding garments from among the plurality of garments, as a garment that needs to be separated from the other garments. In addition, for example, in a case in which the garment treatment device 1000 is a dryer, based on information about whether a garment is machine-dryable among the garment information, the garment treatment device 1000 may determine a garment that is not machine-dryable from among the plurality of garments, as a garment that needs to be separated from the other garments.

Accordingly, the user may be provided with information about a garment that needs to be washed or dried separately.

According to an embodiment of the disclosure, as the user causes a garment to be recognized by the tag reader on the front surface of the garment treatment device 1000 before putting the garment into the drum, the garment treatment device 1000 may output information about whether the garment may stain other garments.

For example, the garment treatment device 1000 may display information about a degree of staining of a garment recognized by the tag reader on the front surface thereof. In addition, for example, based on garment information of a garment accommodated in the drum and garment information of a garment recognized by the tag reader on the front surface, the garment treatment device 1000 may determine whether the garment recognized by the tag reader on the front surface may stain the garment accommodated in the drum.

Based on determining that there is a garment that needs to be separated from other garments, the garment treatment device 1000 may output guide information 101 for guiding the user through separating the garment that needs to be separated from the other garments, along with pieces of identification information 103 and 105 of the garment that needs to be separated. For example, the garment treatment device 1000 may display a garment name 103 and an identification image 105 of the garment that needs to be separated, through a display on a control panel 1510.

In addition, for example, the garment treatment device 1000 may display the type or color of the garment that needs to be separated. In addition, the garment treatment device 1000 may output identification information of the garment that needs to be separated, as a sound.

According to an embodiment of the disclosure, when a user input for powering on the garment treatment device 1000 is received, the garment treatment device 1000 may determine whether there is a garment that needs to be separated, and output the guide information 101.

In addition, according to an embodiment of the disclosure, when a user input for starting washing or drying is received, the garment treatment device 1000 may determine whether there is a garment that needs to be separated, and output the guide information 101. In this case, the garment treatment device 1000 may output the guide information 101 and temporarily stop washing or drying.

Based on receiving a user input to start washing or drying, the garment treatment device 1000 may control garment treatment components to wash or dry a plurality of garments.

For example, based on receiving a user input for starting washing, which is input after the garment that needs to be separated is unloaded according to the guide information 101, the garment treatment device 1000 may control washing components to wash the remaining garments. In addition, for example, based on receiving a user input for starting drying, which is input after the garment that needs to be separated is unloaded according to the guide information 101, the garment treatment device 1000 may control drying components to wash the remaining garments.

According to an embodiment of the disclosure, as the garment treatment device 1000 receives a user input for causing the tag reader 1900 to recognize the tag 10 of the garment, the garment treatment device 1000 may display a washing method or a drying method corresponding to the tag ID of the recognized tag 10. For example, the garment treatment device 1000 may display information about whether the garment needs to be hand-washed or needs to be washed with cold water.

According to an embodiment of the disclosure, the garment treatment device 1000 may rotate the drum 100 to move the position of the garment that needs to be separated to the top of a plurality of garments of the laundry 50, such that the garment that needs to be separated among the plurality of garments of the laundry 50 is visible in the drum 100.

According to an embodiment of the disclosure, in a case in which a notification is set to be triggered when a garment is detected in correspondence to a tag ID, the garment treatment device 1000, based on detecting the tag ID of the garment for the notification is set, may output a notification that the garment for which the notification is set has been loaded into the garment treatment device 1000.

According to an embodiment of the disclosure, the garment treatment device 1000 may output guide information for guiding the user through a method of washing the garment that needs to be separated, along with a method of washing the other garments.

Accordingly, the garment treatment device 1000 may guide the user through separating a garment that may stain other garments before washing. In addition, the garment treatment device 1000 may guide the user through classifying a garment that is not machine-dryable before drying.

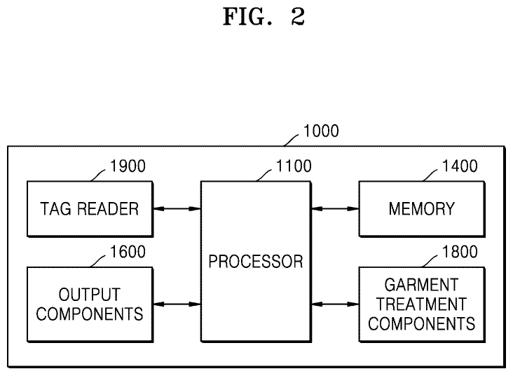

FIG. 2 illustrates a block diagram of the garment treatment device 1000 according to an embodiment of the disclosure.

Referring to FIG. 2, the garment treatment device 1000 may include a processor 1100, a memory 1400, output components 1600, garment treatment components 1800, and the tag reader 1900.

The processor 1100 may generally control the overall operation of the garment treatment device 1000. The processor 1100 may execute programs stored in the memory 1400 to control the output components 1600, the garment treatment components 1800, and the tag reader 1900.

The memory 1400 stores various pieces of information, data, instructions, programs, and the like necessary for an operation of the garment treatment device 1000. For example, the memory 1400 may store garment information in correspondence to a tag ID of a tag attached to a garment.

The output components 1600 may include a display (not shown) and audio output components (not shown). The display may output image data processed by an image processor (not shown) through a display panel (not shown) under control of the processor 1100. The audio output components may output a sound signal to the outside of the garment treatment device 1000.

The garment treatment components may include at least one of washing components (not shown), drying components (not shown), or steam generation components (not shown). In a case in which the garment treatment device 1000 is a washing machine, the garment treatment components may include washing components. In a case in which the garment treatment device 1000 is a dryer, the garment treatment components may include drying components. In a case in which the garment treatment device 1000 is a device capable of both washing and drying, the garment treatment components may include washing components and drying components. In a case in which the garment treatment device 1000 is a garment management device, the garment treatment components may include drying components and steam generation components.

The washing components may include a drum and a rotation motor that rotates the drum. In addition, the washing components may include a water supply valve and a drain valve. The processor 1100 may control the washing components to perform a washing cycle, a rinse cycle, and a dehydration cycle.

The drying components may include at least one of a heat pump configured to remove moisture from laundry by circulating a refrigerant, or a heater configured to remove moisture from laundry by heating air. The processor 1100 may control the drying components to perform a drying cycle. The drying cycle may be a cycle of removing moisture from laundry.

The steam generation components may generate steam by heating water. The steam generated by the steam generation components may be sprayed into a management chamber inside the garment management device by blowing components.

The tag reader 1900 may include, but is not limited to, an RFID reader, an NFC reader, a QR code reader, or a barcode reader. The tag reader 1900 may be provided inside the garment treatment device 1000 to detect a garment in the drum. In addition, the tag reader 1900 may be provided on a front surface or an upper surface of the garment treatment device 1000.

The RFID reader may transmit a radio wave of a predetermined frequency through an antenna. As an RFID tag enters a recognition area of the RFID reader, the RFID reader and the RFID tag may transmit and receive information to and from each other.

RFID tags may include passive RFID tags. A passive RFID tag may obtain power from the RFID reader by using radio waves received from the RFID reader, and transmit stored information to the RFID reader. The passive RFID tag may use a load modulation method or a backscattering method, but is not limited thereto.

According to an embodiment of the disclosure, the antenna of the RFID reader may be provided to face the drum or the management chamber, and in this case, the RFID reader may obtain tag information from a tag of a garment in the drum or the management chamber.

According to an embodiment of the disclosure, the antenna of the RFID reader may be provided to face the outside of the front surface or the upper surface of the garment treatment device 1000, and in this case, the RFID reader may obtain tag information from a garment located outside the garment treatment device 1000. For example, the RFID reader may obtain tag information from a tag of a garment in a laundry basket located outside the garment treatment device 1000.

The NFC reader may transmit a magnetic field through an antenna of the NFC reader. The NFC tag may include a loop antenna implemented in the form of a coil. As an NFC tag approaches the NFC reader, a magnetic field may be formed between the antenna of the NFC reader and an antenna of the NFC tag, and communication may be performed between the NFC reader and the NFC tag by using a current generated in the formed magnetic field. According to an embodiment of the disclosure, based on receiving a user input for bringing an NFC tag of a garment closer to the NFC reader of the garment treatment device 1000, the NFC reader may obtain tag information from the NFC tag of the garment.

The QR code reader may include a red-green-blue (RGB) camera or an infrared camera. In addition, the QR code reader may obtain tag information by recognizing a QR code from a QR code image obtained through the RGB camera or infrared camera.

At least one processor 1100 may obtain garment information of a plurality of garments accommodated in the garment treatment device 1000, through the tag reader 1900. The at least one processor 1100 may determine whether there is a garment that needs to be separated from the other garments among the plurality of garments, based on the obtained garment information. Based on determining that there is a garment that needs to be separated from the other garments, the at least one processor 1100 may output, through the output components 1600, guide information for guiding the user through separating the garment that needs to be separated from the other garments, along with identification information of the garment that needs to be separated.

The at least one processor 1100 may control the garment treatment components 1800 according to a user input in response to the guide information, to wash or dry the other garments with or without the garment that needs to be separated.

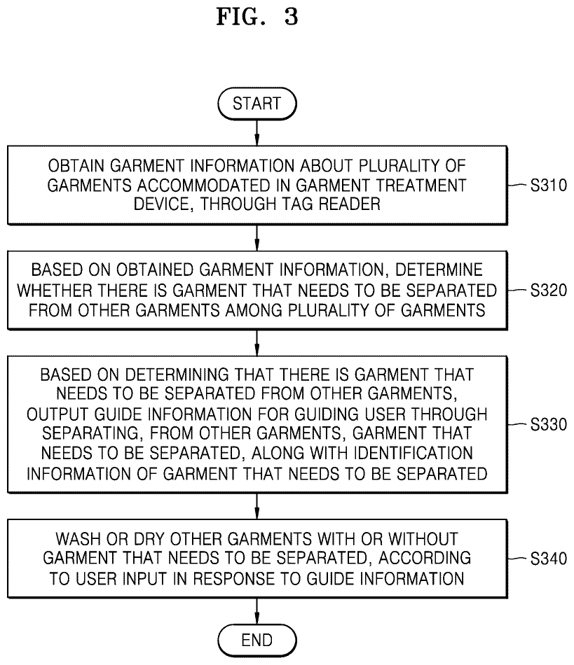

FIG. 3 is a flowchart of a method, performed by the garment treatment device 1000, of guiding a user through separating a garment, according to an embodiment of the disclosure.

In operation S310, the garment treatment device 1000 may obtain garment information about a plurality of garments accommodated in the garment treatment device 1000, through a tag reader.

The garment treatment device 1000 may obtain tag information from a tag attached to a garment, through the tag reader. The tag information may include, in addition to a tag ID, garment information such as a product number, type, color, size, serial number, and the like of the garment.

The garment treatment device 1000 may obtain garment information stored in the garment treatment device 1000 or a server in correspondence to the tag ID. The garment information may include a product number, type, color, size, serial number, name, manufacturer, wearing season, time of manufacture, degree of staining, washing method, drying method, or care instructions of the garment.

The stored garment information may be garment information previously received through a user interface of the garment treatment device 1000. In addition, the stored garment information may be garment information received from a garment server. In addition, the stored garment information may be garment information previously input by the user through a user device.

According to an embodiment of the disclosure, when the garment treatment device 1000 receives a user input for powering on the garment treatment device 1000, the garment treatment device 1000 may obtain garment information about a garment accommodated in the garment treatment device 1000 through the tag reader.

According to an embodiment of the disclosure, when the garment treatment device 1000 receives a user input for closing a door after the garment treatment device 1000 is powered on, the garment treatment device 1000 may obtain garment information about a garment accommodated in the garment treatment device 1000 through the tag reader.

According to an embodiment of the disclosure, the garment treatment device 1000 may obtain garment information of a garment accommodated in the drum. According to an embodiment of the disclosure, the garment treatment device 1000 may obtain garment information of a garment located around the garment treatment device 1000. For example, the garment treatment device 1000 may obtain garment information of a garment in a laundry basket located around the garment treatment device 1000.

In operation S320, based on the obtained garment information, the garment treatment device 1000 may determine whether there is a garment that needs to be separated from other garments among the plurality of garments.

The garment treatment device 1000 may identify a garment that needs to be separated from among the plurality of garments, based on material information, color information, information about a degree of staining, washing method information, or drying method information (e.g., a drying temperature) included in the garment information.

For example, when materials of most of the plurality of garments are cotton or synthetic fiber, and there is at least one garment containing wool, silk, or leather, the garment treatment device 1000 may determine the garment containing wool, silk, or leather, as a garment to be washed separately or dried separately.

In addition, for example, when there is a garment of which the brightness and saturation is greater than or equal to reference values and the washing method is separate wash, among the plurality of garments, the garment treatment device 1000 may determine that the garment is likely to stain other garments and is to be washed separately.

In addition, for example, the garment treatment device 1000 may identify a garment that is likely to stain other garments from among the plurality of garments based on information about degrees of staining, and determine the identified garment as a garment to be washed separately.

In addition, for example, when there are both a hand-wash-only garment and a machine-washable garment, the garment treatment device 1000 may determine the hand-wash-only garment as a garment to be washed separately.

In addition, for example, when the temperature of the wash water is set to be a high-temperature option, and a garment that needs to be washed with cold water and a garment that does not need to be washed with cold water are together included in the garment treatment device 1000, the garment treatment device 1000 may determine the garment that needs to be washed with cold water, as a garment to be washed separately.

In addition, for example, when there are both a dark-colored garment and a light-colored garment, the garment treatment device 1000 may determine the light-colored garment as a garment to be washed separately.

In addition, for example, when the plurality of garments are classified into first garments to be washed with standard wash, and second garments to be washed with wool wash, the garment treatment device 1000 may determine the second garments, which are fewer than the first garments, as garments to be washed separately.

In addition, for example, when there is at least one garment that is not machine-dryable among the plurality of garments, the garment treatment device 1000 may determine the at least one garment that is not machine-dryable, as a garment to be dried separately.

In operation S330, based on determining that there is a garment that needs to be separated from other garments, the garment treatment device 1000 may output guide information for guiding the user through separating the garment that needs to be separated from the other garments, along with identification information of the garment that needs to be separated.

For example, based on determining that there is a garment that needs to be separated from other garments, the garment treatment device 1000 may display an identification image of the garment that needs to be separated.

According to an embodiment of the disclosure, the garment treatment device 1000 may output guide information for guiding the user through a method of washing the garment that needs to be separated, along with a method of washing the other garments.

According to an embodiment of the disclosure, based on determining that there is a garment that needs to be separated from the other garments, the garment treatment device 1000 may output a predetermined notification sound. The notification sound may include a predetermined single-tone buzzer, melody buzzer, or notification voice. The notification voice may be, for example, a voice signal indicating the name or type of the garment. The notification voice may be, for example, a voice signal indicating guide information.

According to an embodiment of the disclosure, the garment treatment device 1000 may selectively display a garment that is likely to be stained, and a garment that is likely to stain other garments. According to an embodiment of the disclosure, the garment treatment device 1000 may display the types, number, images, and the like of garments that are likely to be stained, and the types, number, images, and the like of garments that are likely to stain other garments.

According to an embodiment of the disclosure, the garment treatment device 1000 may provide a user interface for asking the user which of light-colored garments and dark-colored garments to unload.

According to an embodiment of the disclosure, the garment treatment device 1000 may display information for guiding the user through unloading a group of garments that are likely to be stained, or a group of garments that are likely to stain other garments, which has a smaller number than the other group.

According to an embodiment of the disclosure, even when only one garment, which is not machine-dryable, is accommodated in the drum, the garment treatment device 1000 may notify that the garment is not machine-dryable.

According to an embodiment of the disclosure, the garment treatment device 1000 may transmit identification information of a garment that needs to be separated, to a user device through a server, and request the user device to output guide information for guiding the user through separating the garment from the other garments. As the user device receives a request to output the guide information from the server, the user device may output the guide information for guiding the user through separating the garment that needs to be separated from the other garments, along with identification information of the garment that needs to be separated.

According to an embodiment of the disclosure, the garment treatment device 1000 may rotate the drum to move the position of the garment that needs to be separated, to the top of the plurality of garments, such that the garment that needs to be separated among the plurality of garments is visible in the drum.

In operation S340, the garment treatment device 1000 may wash or dry the other garments with or without the garment that needs to be separated, according to a user input in response to the guide information.

For example, based on receiving a user input for starting washing, which is input after the garment that needs to be separated is unloaded according to the guide information, the washing components may be controlled to wash the remaining garments.

In addition, for example, based on receiving a user input for starting drying, which is input after the garment that needs to be separated is unloaded according to the guide information, the drying components may be controlled to dry the remaining garments.

In addition, for example, based on receiving a user input for starting washing or drying without unloading the garment that output as needing to be separated, the garment treatment device 1000 may wash or dry the plurality of garments.

When washing or drying is performed more than a predetermined number of times for the garment that needs to be separated, as the garment that needs to be separated is washed or dried without being separated after the guide information is output, the garment treatment device 1000 may determine the unseparated garment as a garment that does not need to be separated.

According to an embodiment of the disclosure, the garment information of the plurality of garments may include notification setting information about whether to output a notification that the garment has been loaded into the garment treatment device 1000. In addition, based on the notification setting information, the garment treatment device 1000 may, based on detecting a tag ID of a garment for which a notification is set to be output among the plurality of garments, output a notification that the garment has been loaded into the garment treatment device 1000. In addition, the garment treatment device 1000 may display garment information of the garment for which a notification is set to be output, along with outputting the notification.

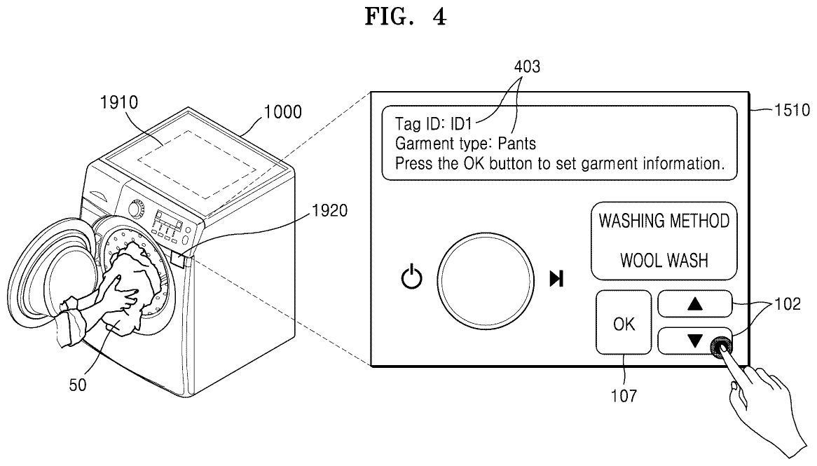

FIG. 4 illustrates a method, performed by the garment treatment device 1000, of storing garment information through a user interface, according to an embodiment of the disclosure.

Referring to FIG. 4, the garment treatment device 1000 may store garment information in correspondence to a tag ID of a garment 50.

For example, the garment treatment device 1000 may include an RFID reader 1910 or a QR code reader 1920. The RFID reader 1910 may obtain tag information from a tag of the garment 50 in the drum. The QR code reader 1920 may include a general RGB camera or infrared camera.

In response to receiving a user input for bringing the tag of the garment 50 closer to the tag reader 1910 or 1920, the garment treatment device 1000 may obtain the tag information of the garment 50. In addition, as the tag information of the garment 50 is obtained, the garment treatment device 1000 may display obtained tag information 403 as illustrated in FIG. 4.

For example, as the user brings a QR code of garment 50 closer to the QR code reader 1920, the garment treatment device 1000 may obtain QR code information of the garment 50 through the QR code reader 1920. The QR code information may include garment information. The garment treatment device 1000 may determine a serial number in the garment information as a tag ID, and store the garment information in correspondence to the tag ID.

In addition, for example, when the garment 50 is loaded into the drum, the garment treatment device 1000 may obtain tag information included in the RFID tag of the garment 50 through the RFID reader 1910. The tag information may include an RFID tag ID and garment information. The garment treatment device 1000 may store the garment information in correspondence to the RFID tag ID.

According to an embodiment of the disclosure, the garment treatment device 1000 may store garment information that is input by the user in correspondence to the tag ID.

For example, the garment treatment device 1000 may receive a user input for selecting a washing method by pressing buttons 102 on the control panel 1510 of the garment treatment device 1000. In addition, based on receiving a user input of pressing a setting button 107, the garment treatment device 1000 may store the selected washing method as a washing method for the garment 50 of which the tag has been recognized, in correspondence to the tag ID.

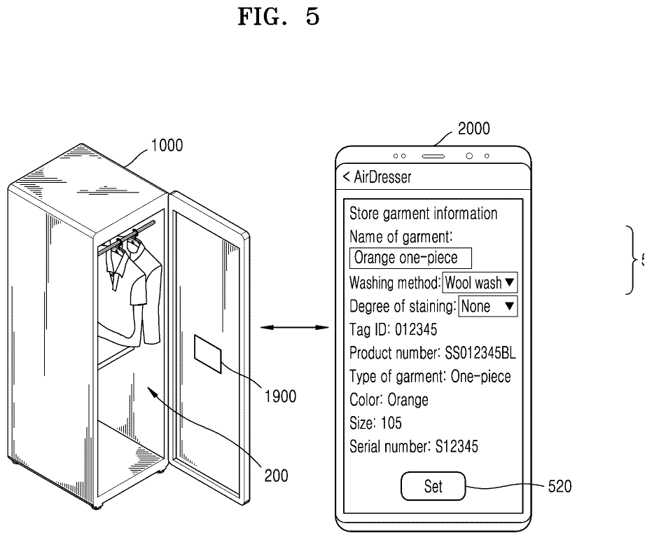

FIG. 5 illustrates a method, performed by the garment treatment device 1000, of storing garment information through a user device 2000, according to an embodiment of the disclosure.

Referring to FIG. 5, the garment treatment device 1000 may establish a short-range wireless communication with the user device 2000, and exchange tag information and garment information with the user device 2000 through the established short-range wireless communication.

As illustrated in FIG. 5, the garment treatment device 1000 may be a garment management device, and the garment treatment device 1000 may recognizes an RFID tag of a garment accommodated in a management chamber 200 through the RFID tag reader 1900, and obtain tag information from the RFID tag.

The garment treatment device 1000 may transmit the tag information to the user device 2000 through the established short-range wireless communication.

For example, based on receiving a user input for inputting garment information about a garment accommodated in the management chamber 200, the user device 2000 may request tag information from the garment treatment device 1000. The garment treatment device 1000 may transmit the tag information obtained from the garment, to the user device 2000. When there are a plurality of garments with RFID tags attached thereto, the garment treatment device 1000 may transmit a plurality of pieces of tag information to the user device 2000.

The user device 2000 may display the received tag information. For example, as illustrated in FIG. 5, the user device 2000 may display a tag ID, a product number, a garment type, a color, a size, and a serial number.

In addition, the user device 2000 may display a user interface for inputting garment information. For example, the user device 2000 may include input fields 510 for inputting a garment name, a washing method, and a degree of staining. Based on receiving a user input of inputting garment information into the input fields 510 and pressing a setting button 520, the user device 2000 may store the garment information included in the tag information in correspondence to the tag ID, and the garment information that is input by the user.

In addition, the user device 2000 may transmit the tag ID and the garment information stored in correspondence to tag ID, to the garment treatment device 1000.

In addition, the user device 2000 may transmit the tag ID and the garment information stored in correspondence to the tag ID, to a server that connects the garment management device to the user device 2000, based on a user account.

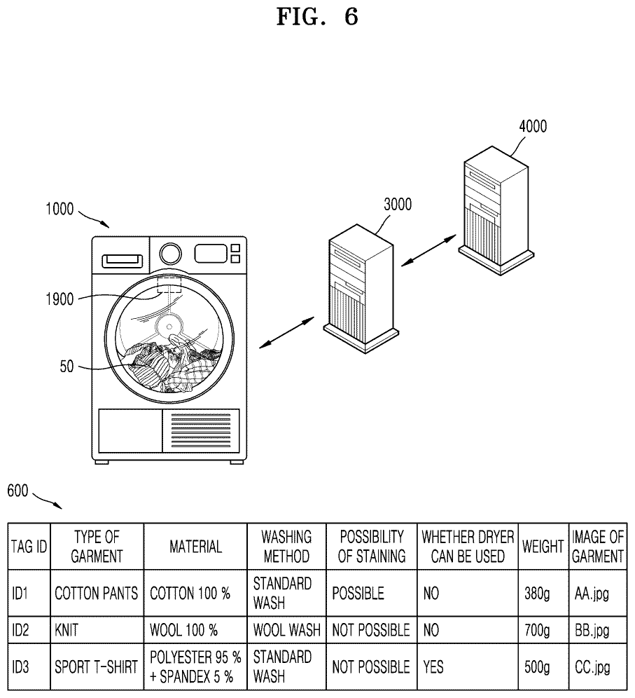

FIG. 6 illustrates a method, performed by the garment treatment device 1000, of obtaining garment information stored in a garment server 4000, according to an embodiment of the disclosure.

Referring to FIG. 6, as the tag information of the garment 50 is obtained, the garment treatment device 1000 may request garment information corresponding to the tag information from a server 3000 based on a user account. The server 3000 may request the garment information corresponding to the tag information from the garment server 4000, and transmit the garment information received from the garment server 4000, to the garment treatment device 1000.

The garment treatment device 1000 may obtain tag information of a tag attached to the garment 50 through the RFID reader 1900. The tag information may include a tag ID. When there are a plurality of garments 50 with tags attached thereto, the garment treatment device 1000 may obtain tag information from the plurality of garments.

The garment treatment device 1000 may request garment information corresponding to the obtained tag information from the server 3000 and transmit the tag information, based on the user account. The server 3000 may be a server for managing the garment treatment device 1000 based on a user account.

As the tag information is received from the garment treatment device 1000, the server 3000 may receive garment information from the garment server 4000 based on the tag information. For example, when the tag information includes identification information of the manufacturer of the garment to which the tag is attached, the server 3000 may transmit at least one of a tag ID, a serial number, or a product number to the garment server 4000 corresponding to the identification information of the manufacturer, and receive garment information corresponding to the information transmitted from the garment server 4000.

The garment information received from the garment server 4000 may include, but is not limited to, a garment type, a material, a washing method, a degree of staining, whether a dryer may be used, a weight, and a garment image.

As the garment information is received from the garment server 4000, the server 3000 may store the received garment information in correspondence to the tag ID of the garment 50. In addition, the server 3000 may transmit the received garment information to the garment treatment device 1000 corresponding to the user account. In a case in which information about a plurality of garment treatment devices (e.g., washing machines, dryers, or garment management devices) is stored in correspondence to the user account, the server 3000 may request the plurality of garment treatment devices 1000 to store the tag information and the received garment information in correspondence to the tag ID.

As the garment information corresponding to the tag information of the garment 50 is received from the server 3000, the garment treatment device 1000 may store the tag information and the received garment information in correspondence to the tag ID of the garment 50, as shown in Table 1 600.

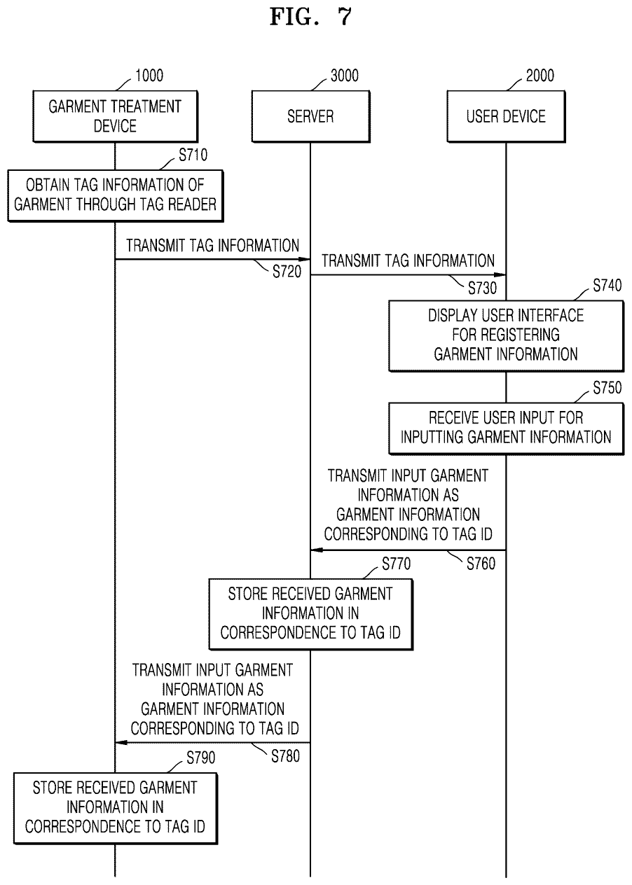

FIG. 7 illustrates a flowchart of a method, performed by the garment treatment device 1000, of obtaining garment information from the user device 2000 through the server 3000, according to an embodiment of the disclosure.

In operation S710, the garment treatment device 1000 may obtain tag information of a garment through a tag reader.

In operation S720, the garment treatment device 1000 may transmit the tag information to the server 3000.

The garment treatment device 1000 may transmit the tag information to the server 3000 based on a user account.

According to an embodiment of the disclosure, as the tag information is obtained, the garment treatment device 1000 may determine whether the obtained tag information is pre-stored tag information. Based on determining that the obtained tag information is not pre-stored tag information, the garment treatment device 1000 may transmit the obtained tag information to the server 3000.

According to an embodiment of the disclosure, when the garment treatment device 1000 receives a user input for registering the garment in the server 3000, the garment treatment device 1000 may transmit the obtained tag information to the server 3000.

According to an embodiment of the disclosure, when the garment treatment device 1000 receives a user input for inputting garment information through the user device 2000, the garment treatment device 1000 may transmit the obtained tag information to the server 3000.

In operation S730, the server 3000 may transmit the tag information to the user device 2000.

The server 3000 may transmit the tag information to the user device 2000 corresponding to the user account.

According to an embodiment of the disclosure, when receiving a request for the tag information from the user device 2000, the garment treatment device 1000 may transmit the tag information to the user device 2000.

According to an embodiment of the disclosure, when the tag information is received from the garment treatment device 1000, the server 3000 may transmit a push notification including the tag information to the user device 2000.

In operation S740, the user device 2000 may display a user interface for registering garment information.

The user interface for registering garment information may include the tag information received from the server 3000. In addition, the user interface for registering garment information may include a user interface for inputting garment information.

According to an embodiment of the disclosure, when the user device 2000 receives a user input for inputting garment information, the user device 2000 may display a user interface for inputting garment information.

In this case, the user device 2000 may receive tag information of a plurality of garments from the server 3000. In addition, the user device 2000 may display a garment list of the plurality of garments of which the tag information has been received, and based on receiving a user input for selecting one garment from the garment list, display a user interface for inputting garment information of the selected garment. The user may identify the garment through a garment type, a color, a material, a serial number, or the like included in the tag information in the user interface.

According to an embodiment of the disclosure, the user device 2000 may display the push notification received from the server 3000, and based on receiving a user input for selecting the push notification, display a user interface for inputting garment information.

In operation S750, the user device 2000 may receive a user input for inputting garment information.

The user device 2000 may receive a user input for inputting garment information through the displayed user interface. The garment information may include a garment name, a washing method, a drying method, a degree of staining, and a garment image, but is not limited thereto.

In operation S760, the user device 2000 may transmit the input garment information to the server 3000 as garment information corresponding to the tag ID.

Based on receiving a user input for registering the input garment information, the user device 2000 may transmit the input garment information to the server 3000 as garment information corresponding to the tag ID.

In operation S770, the server 3000 may store the received garment information in correspondence to the tag ID.

In operation S780, the server 3000 may transmit the input garment information to the garment treatment device 1000 as garment information corresponding to the tag ID.

In this case, when there are a plurality of garment treatment devices 1000 (e.g., washing machines, dryers, or garment management devices) stored in correspondence to the user account, the server 3000 may transmit the tag information and the input garment information to each of the plurality of garment treatment devices 1000.

In operation S790, the garment treatment device 1000 may store the received garment information in correspondence to the tag ID.

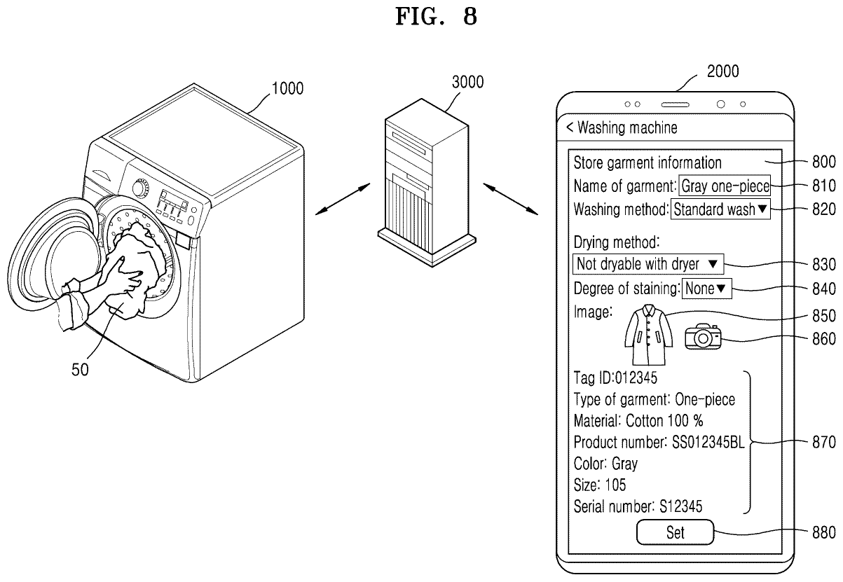

FIG. 8 illustrates a method, performed by the garment treatment device 1000, of obtaining garment information from the user device 2000 through the server 3000, according to an embodiment of the disclosure.

Referring to FIG. 8, the garment treatment device 1000 may obtain garment information through the user device 2000.

For example, based on receiving a user input for causing the tag of the garment 50 to be recognized, the garment treatment device 1000 may obtain tag information of the garment 50 and display the obtained tag information. In addition, the garment treatment device 1000 may receive a user input for selecting a button for inputting, through the user device 2000, garment information of the garment 50 of which the tag information is displayed.

Based on receiving a user input for inputting garment information through the user device 2000, the garment treatment device 1000 may transmit the obtained tag information and a garment information input request to the server 3000.

The server 3000 may transmit the received tag information and garment information input request to the user device 2000. According to an embodiment of the disclosure, the server 3000 may transmit the received tag information and garment information input request, as push notification information.

Based on receiving a push notification for the garment information input request, the user device 2000 may display a user interface for inputting garment information. A user interface 800 for inputting garment information may include received tag information 870.

The user device 2000 may input, through the user interface 800, garment information about the garment 50 of which the tag has been recognized. For example, as illustrated in FIG. 8, the user device 2000 may receive a user input for inputting identification information of the garment 50 into a garment name input field 810. In addition, the user device 2000 may receive a user input for selecting field values in fields 820, 830, and 840 for selecting a washing method, a drying method, and a degree of staining, respectively.

In addition, the user interface for inputting garment information may include a photographing button 860 for capturing a garment image. As the user device 2000 receives a user input for photographing the garment 50 through the photographing button 860 for capturing a garment image, the user device 2000 may display a captured image 850.

As a user input of pressing a setting button 880 after inputting garment information is received, the user device 2000 may transmit the input garment information to the server 3000 as garment information corresponding to the tag ID. The server 3000 may store the received garment information in correspondence to the tag ID, and transmit the received garment information to the garment treatment device 1000. The garment treatment device 1000 may store the received garment information in correspondence to the tag ID.

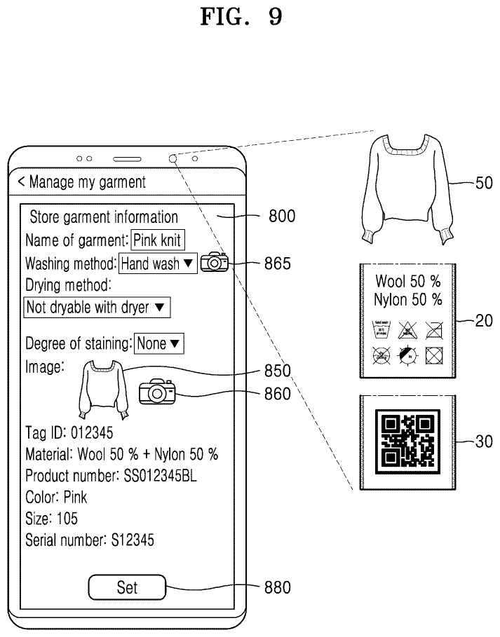

FIG. 9 illustrates a method, performed by the user device 2000, of obtaining garment information by using a camera, according to an embodiment of the disclosure.

Referring to FIG. 9, the user device 2000 may obtain garment information by photographing a garment or information printed on a tag of the garment.

As a user input for photographing the garment 50 through the photographing button 860 in the user interface 800 for inputting garment information, the user device 2000 may obtain the garment image 850.

The user device 2000 may receive a user input for photographing information printed on a tag 20 or 30 of the garment 50, through a photographing button 865 in the user interface 800. The information printed on the tag 20 or 30 may include, but is not limited to, material information, washing method information, drying method information, and QR code information.

The user device 2000 may obtain material information from a captured image through a text recognition module. In addition, the user device 2000 may obtain washing method information from a captured image through an image recognition module. In addition, the user device 2000 may display the obtained material information or washing method information. For example, when the washing method printed on the tag is hand wash and the garment is not dryable with a dryer, the user device 2000 may display that ‘Hand wash’ is selected as the washing method and that ‘Not dryable with dryer’ is selected as the drying method, in the user interface 800 for inputting garment information.

The user device 2000 may obtain QR code information from a captured image through a QR code recognition module, and display garment information included in the QR code information.

As a user input of pressing the setting button 880 after inputting garment information is received, the user device 2000 may transmit the input garment information to the server 3000 as garment information corresponding to the tag ID. The server 3000 may store the received garment information in correspondence to the tag ID, and transmit the received garment information to the garment treatment device 1000. The garment treatment device 1000 may store the received garment information in correspondence to the tag ID.

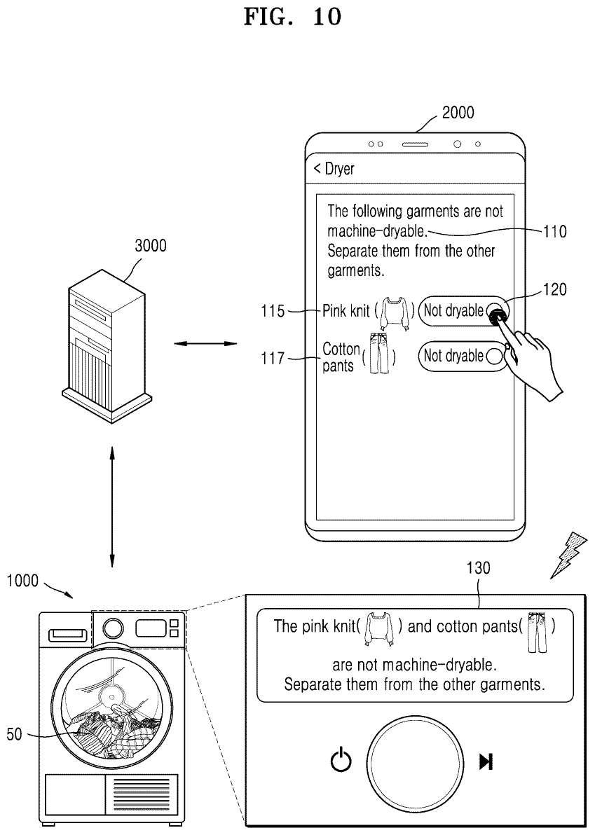

FIG. 10 illustrates a method, performed by the garment treatment device 1000, of guiding a user through separating a garment depending on whether the garment is machine-dryable, according to an embodiment of the disclosure.

Referring to FIG. 10, the garment treatment device 1000 may be a dryer and may display guide information for guiding the user through separating a garment is not machine-dryable.

For example, as a user input for powering on the garment treatment device 1000 is received, the garment treatment device 1000 may obtain tag information from a tag of at least one garment 50 in the drum. In addition, based on information about whether the garment is machine-dryable, which is included in the obtained tag information or pre-stored in correspondence to a tag ID, the garment treatment device 1000 may determine whether the at least one garment 50 is machine-dryable.

The garment treatment device 1000 may identify a garment that is not machine-dryable from among the at least one garment, and display identification information of the garment that is not machine-dryable. For example, the garment treatment device 1000 may display at least one of the tag ID, a garment name, a garment type, or a garment image, as identification information of the garment.

In addition, the garment treatment device 1000 may display guide information 130 for guiding the user through drying separately the garment that is not machine-dryable, along with the identification information for the garment that is not machine-dryable.

The garment treatment device 1000 may transmit information about the garment to be dried separately, to the user device 2000 through the server 3000, such that information about the garment to be dried separately is provided to the user device 2000. For example, the garment treatment device 1000 may transmit the information about the garment to be dried separately to the server 3000, and the server 3000 may transmit the received information to the user device 2000 by using a push notification method.

Based on receiving a user input for selecting a push notification, the user device 2000 may display guide information 110 for guiding the user through drying separately the garment that is not machine-dryable, along with pieces of identification information 115 and 117 of the garment that is not machine-dryable.

In addition, the user device 2000 may display a user interface 120 for changing information about whether the garment is machine-dryable. Based on receiving a user input for changing ‘Not machine-dryable’ stored for ‘Pink knit’ to ‘Machine-dryable’ through the user interface 120, the user device 2000 may request the server 3000 to change information about whether ‘Pink garment’ is machine-dryable to ‘Machine-dryable’, based on the tag ID of ‘Pink knit’.

Accordingly, in a next drying process, a notification that ‘Pink knit’ needs to be dried separately may not be received without a separate user input.

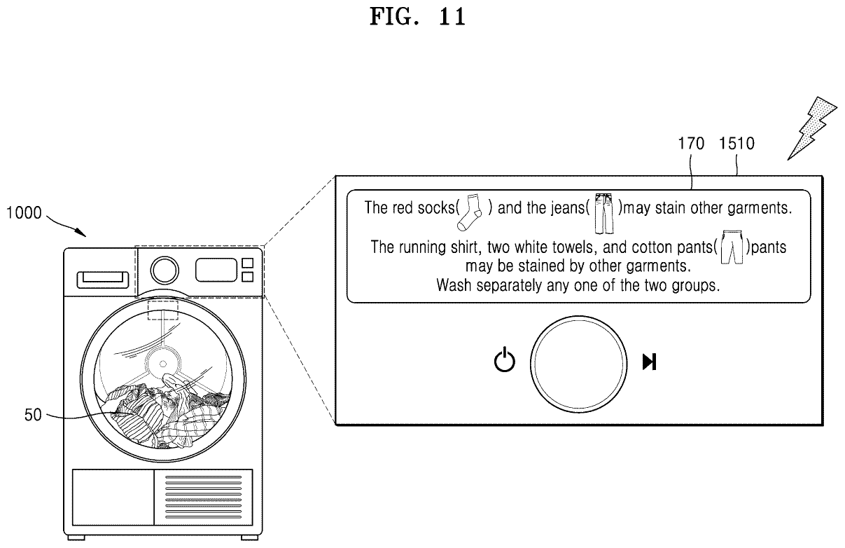

FIG. 11 illustrates a method, performed by the garment treatment device 1000, of providing information about a garment that may stain other garments, according to an embodiment of the disclosure.

Referring to FIG. 11, the garment treatment device 1000 may display not only information about a garment that may stain surrounding garments, but also information about a garment that may be stained by surrounding garments.

As a user input for powering on the garment treatment device 1000 is received, the garment treatment device 1000 may obtain tag information from a tag of at least one garment 50 in the drum. In addition, based on information about whether the garment may stain other garments, which is included in the obtained tag information or pre-stored in correspondence to a tag ID, the garment treatment device 1000 may determine whether the at least one garment 50 may stain other garments or may be stained.

Based on whether the at least one garment 50 may stain other garments or may be stained, the garment treatment device 1000 may display identification information of a garment that is likely to stain other garments, and identification information about a garment that is likely to be stained.

In addition, the garment treatment device 1000 may display guide information 170 for guiding the user through washing separately any one of a group of garments that are likely to stain other garments, and a group of garments that are likely to be stained.

Based on receiving a user input for unloading any one of the displayed garments in the drum, the garment treatment device 1000 may delete the identification information of the unloaded garment.

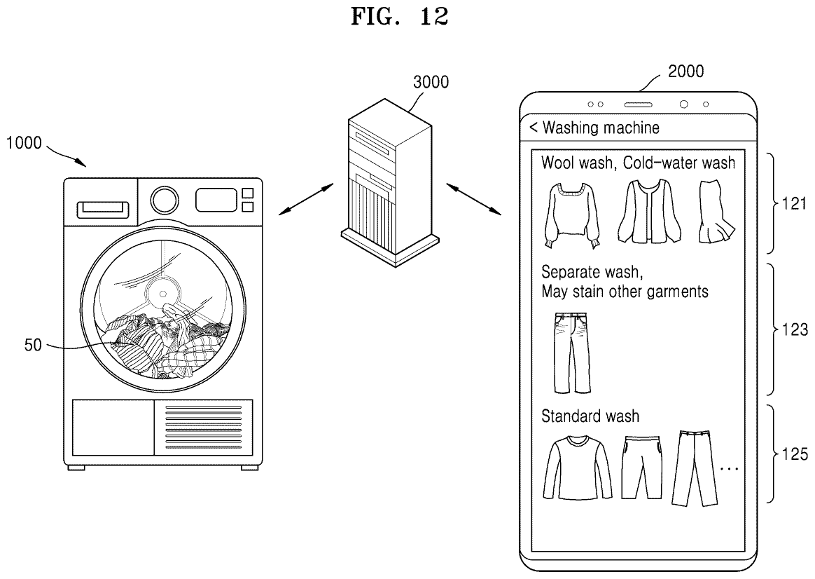

FIG. 12 illustrates a method, performed by the garment treatment device 1000, of classifying a plurality of garments in a drum into a plurality of groups according to washing methods, according to an embodiment of the disclosure.

Referring to FIG. 12, the garment treatment device 1000 may classify a plurality of garments 50 of which the tags are recognized, into a plurality of groups according to washing methods, and guide the user through a washing method for each group.

For example, the garment treatment device 1000 may determine a washing method for each garment based on the tag information of the plurality of garments 50. The garment treatment device 1000 may determine, as one group, garments with the same washing method or garments with similar washing methods and thus predetermined to be washable together, among the plurality of garments 50. For example, the garment treatment device 1000 may determine, as one group, garments of which the washing methods are hand wash or wool wash, determine, as one group, garments of which the degrees of staining are less than or equal to a reference value, and determine, as one group, garments of which the washing methods are general washing methods.

By classifying the plurality of garments 50 into two or more groups, the garment treatment device 1000 may provide identification information for garments belonging to each group, and a washing method for each group.

For example, the garment treatment device 1000 may transmit the identification information of the garments belonging to each group and the washing method for each group, to the user device 2000 through the server 3000. The user device 2000 may display the identification information of the garments belonging to each group, and the washing method for each group, for the plurality of garments 50 in the drum.

For example, as illustrated in FIG. 12, the user device 2000 may classify and display the plurality of garments 50 into a wool wash and cold-water wash group 121, a separate wash group 123, and a standard wash group 125.

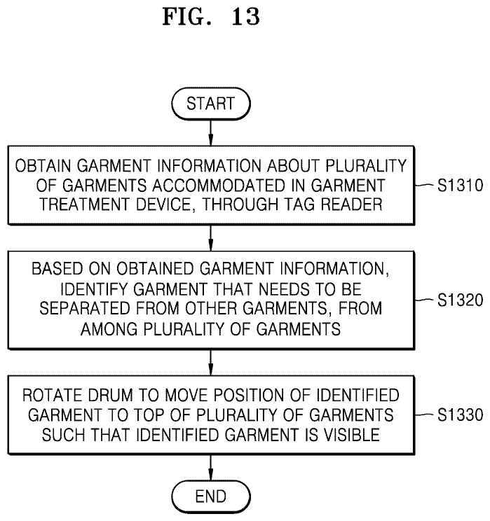

FIG. 13 is a flowchart of a method, performed by the garment treatment device 1000, of moving a garment that needs to be separated to a position where the garment may be easily separated, according to an embodiment of the disclosure.

In operation S1310, the garment treatment device 1000 may obtain garment information about a plurality of garments accommodated in the garment treatment device 1000, through a tag reader.

The garment treatment device 1000 may obtain tag information from a tag attached to a garment, through the tag reader. The garment treatment device 1000 may obtain garment information stored in the garment treatment device 1000 in correspondence to a tag ID.

According to an embodiment of the disclosure, when the garment treatment device 1000 receives a user input for closing a door after the garment treatment device 1000 is powered on, the garment treatment device 1000 may obtain garment information of a plurality of garments accommodated in the garment treatment device 1000 through the tag reader.

In operation S1320, based on the obtained garment information, the garment treatment device 1000 may identify a garment that needs to be separated from other garments, from among the plurality of garments.

The garment treatment device 1000 may identify a garment that needs to be separated from among the plurality of garments, based on material information, color information, information about a degree of staining, washing method information, or drying method information included in the garment information.

Based on determining that there is a garment that needs to be separated from other garments, the garment treatment device 1000 may output guide information for guiding the user through separating the garment that needs to be separated from the other garments, along with identification information of the garment that needs to be separated.

In operation S1330, the garment treatment device 1000 may rotate the drum to move the position of the identified garment to the top of the plurality of garments such that the identified garment is visible.

The garment treatment device 1000 may include a camera capable of photographing a garment in the drum. Based on determining the garment that needs to be separated, the garment treatment device 1000 may photograph the plurality of garments in the drum by using the camera. For example, the garment treatment device 1000 may repeat an operation of rotating the drum by a predetermined angle or for a predetermined time period, and then photographing the inside of the drum, at a predetermined cycle.

Based on a captured image obtained from the camera and image information of the garment that needs to be separated, the garment treatment device 1000 may determine whether the garment that needs to be separated is located on top of the plurality of garments.

For example, based on detecting an area of a color and a pattern of the garment that needs to be separated in the captured image, the garment treatment device 1000 may determine that the garment that needs to be separated is located on top of the plurality of garments.

For example, based on the area of the color and pattern of the garment that needs to be separated in the captured image being greater than or equal to a predetermined range, the garment treatment device 1000 may determine that the garment that needs to be separated is located on top of the plurality of garments.

Based on determining that the garment that needs to be separated is located on top of the plurality of garments, the garment treatment device 1000 may stop rotating the drum and open the door.

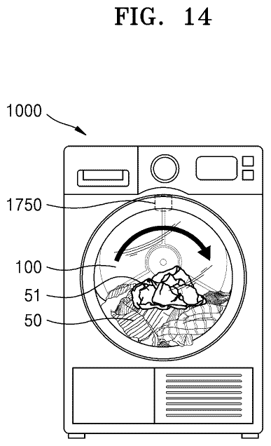

FIG. 14 illustrates a method, performed by the garment treatment device 1000, of rotating the drum to move the position of a garment that needs to be separated, according to an embodiment of the disclosure.

Referring to FIG. 14, the garment treatment device 1000 may monitor, while the drum rotates, whether a garment 51 that needs to be separated is at a position where the garment 51 may be easily unloaded, stop rotating the drum when the garment 51 is at a position where the garment 51 may be easily unloaded, and output a notification to the user.

For example, the garment treatment device 1000 may rotate the drum 100 to move the garment that needs to be separated to the top of the plurality of garments 50 such that the garment that needs to be separated may be easily unloaded from the drum.

The garment treatment device 1000 may include a camera 1750 capable of photographing the plurality of garments 50 in the drum 100. Based on determining the garment 51 that needs to be separated, the garment treatment device 1000 may photograph the plurality of garments 50 in the drum 100 by using the camera 1750. For example, the garment treatment device 1000 may repeat an operation of rotating the drum 100 by a predetermined angle or for a predetermined time period, and then photographing the inside of the drum 100, at a predetermined cycle.

Based on an area of a color and a pattern of the garment 51 that needs to be separated in a captured image being greater than or equal to a predetermined range, the garment treatment device 1000 may determine that the garment 51 that needs to be separated is located on top of the plurality of garments 50.

Based on determining that the garment 51 that needs to be separated is located on top of the plurality of garments 50, the garment treatment device 1000 may stop rotating the drum 100 and open the door.

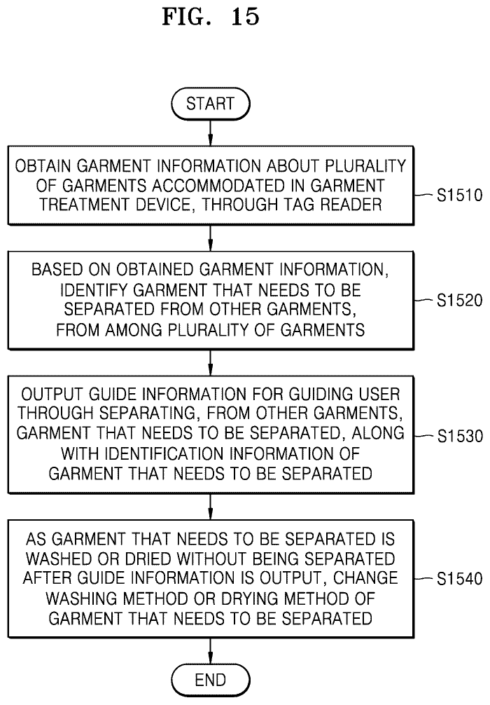

FIG. 15 is a flowchart of a method, performed by the garment treatment device 1000, of changing garment information by learning a user's selection, according to an embodiment of the disclosure.

In operation S1510, the garment treatment device 1000 may obtain garment information about a plurality of garments accommodated in the garment treatment device 1000, through a tag reader.

The garment treatment device 1000 may obtain tag information from a tag attached to a garment, through the tag reader. The garment treatment device 1000 may obtain garment information stored in the garment treatment device 1000 in correspondence to a tag ID.

According to an embodiment of the disclosure, when the garment treatment device 1000 receives a user input for closing the door after the garment treatment device 1000 is powered on, the garment treatment device 1000 may obtain garment information of a plurality of garments accommodated in the garment treatment device 1000 through the tag reader.

In operation S1520, based on the obtained garment information, the garment treatment device 1000 may identify a garment that needs to be separated from other garments, from among the plurality of garments.

The garment treatment device 1000 may identify a garment that needs to be separated from among the plurality of garments, based on material information, color information, information about a degree of staining, washing method information, or drying method information included in the garment information.

In operation S1530, the garment treatment device 1000 may output guide information for guiding the user through separating the garment that needs to be separated from the other garments, along with identification information of the garment that needs to be separated.

Based on determining that there is a garment that needs to be separated from other garments, the garment treatment device 1000 may output guide information for guiding the user through separating the garment that needs to be separated from the other garments, along with identification information of the garment that needs to be separated.

In operation S1540, as the garment that needs to be separated is washed or dried without being separated after the guide information is output, the garment treatment device 1000 may change the washing method or the drying method of the garment that needs to be separated.

The garment treatment device 1000 may receive a user input for starting washing or drying, after the guide information is output. In addition, as washing or drying begins, the garment treatment device 1000 may determine whether the garment that needs to be separated has been separated.

For example, based on tag information of the garment that needs to be separated not being detected, the garment treatment device 1000 may determine that the garment that needs to be separated has been unloaded and thus separated from the other garments.

In addition, based on tag information of the garment that needs to be separated and tag information of the other garments being detected together, the garment treatment device 1000 may determine that the garment that needs to be separated has not been separated.

According to an embodiment of the disclosure, as it is determined that the garment that needs to be separated has not been separated even after a predetermined time period has elapsed after the guide information is output and the user input for starting washing or drying is received, the garment treatment device 1000 may provide the guide information once again.

The garment treatment device 1000 may calculate the number of times the garment that needs to be separated is washed or dried without being separated. In addition, the garment treatment device 1000 may store a washing method or a drying method performed when the garment that needs to be separated is washed or dried without being separated.

Based on the number of times that the garment that needs to be separated is washed or dried without being separated being greater than a predetermined number of times, the garment treatment device 1000 may change the washing method or the drying method of the garment that needs to be separated.

For example, as the number of times the garment that is indicated as needing to be separated based on the degree of staining is washed without being separated is greater than the predetermined number of times, the garment treatment device 1000 may change the washing method of the garment from separate wash to standard wash, or to ‘standard wash or separate wash’. In addition, the garment treatment device 1000 may change information about the degree of staining in the garment information to ‘Low degree of staining’.

Accordingly, in a next washing process, even when a garment that has been indicated as a garment that needs to be separated due to a high degree of staining in the previous washing process is washed together with other garments, the garment treatment device 1000 may not output guide information for guiding the user through washing separately the garment.

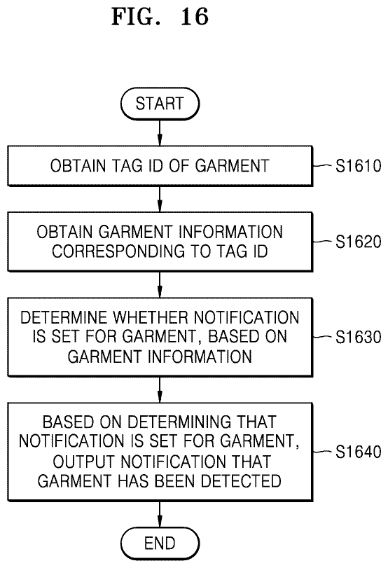

FIG. 16 is a flowchart of a method, performed by the garment treatment device 1000, of providing a notification for a garment for which a notification is set, according to an embodiment of the disclosure.

In operation S1610, the garment treatment device 1000 may obtain a tag ID of a garment.

As a tag of the garment enters the recognition area of the tag reader, the garment treatment device 1000 may obtain tag information of the garment through the tag reader.

For example, in a case in which the recognition area of the tag reader is an area within the drum, when the garment is loaded into the drum, the garment treatment device 1000 may obtain tag information of the garment through the tag reader.

In addition, for example, in a case in which the recognition area of the tag reader is a front area of the garment treatment device 1000, based on a user input for bringing the garment to the front of the garment treatment device 1000, the garment treatment device 1000 may obtain tag information of the garment through the tag reader.

In operation S1620, the garment treatment device 1000 may obtain garment information corresponding to the tag ID.

The garment treatment device 1000 may obtain garment information stored in correspondence to the tag ID.

In operation S1630, the garment treatment device 1000 may determine whether a notification is set for the garment, based on the garment information.

The garment information may include notification setting information. The notification setting information may include information about whether to output a notification when the garment is detected.

In operation S1640, based on determining that a notification is set for the garment, the garment treatment device 1000 may output a notification that the garment has been detected.

For example, based on determining that a notification is set for the garment, the garment treatment device 1000 may output a notification sound. The notification sound may include a predetermined single-tone buzzer, melody buzzer, or notification voice. The notification voice may be, for example, a voice signal indicating the name or type of the garment.

In addition, based on determining that a notification is set in correspondence to the tag ID, the garment treatment device 1000 may display garment information stored in correspondence to the tag ID. For example, the garment treatment device 1000 may display the tag ID obtained from the tag, a garment type, a color, a size, or a material. In addition, for example, the garment treatment device 1000 may display not only the tag information but also a garment name, a garment image, a washing method, or a drying method stored in correspondence to the tag ID.

According to an embodiment of the disclosure, when there are a plurality of garments for which notifications are set among garments in the drum or the management chamber, the garment treatment device 1000 may display garment information of the plurality of garments for which notifications are set. For example, the garment treatment device 1000 may sequentially display the plurality of garments for which notifications are set, one by one. In addition, for example, the garment treatment device 1000 may display a list of the plurality of garments for which notifications are set.

Accordingly, by setting a notification for a garment that the user considers important, it is possible to prevent an important garment from being washed or dried by using an incorrect washing or drying method.

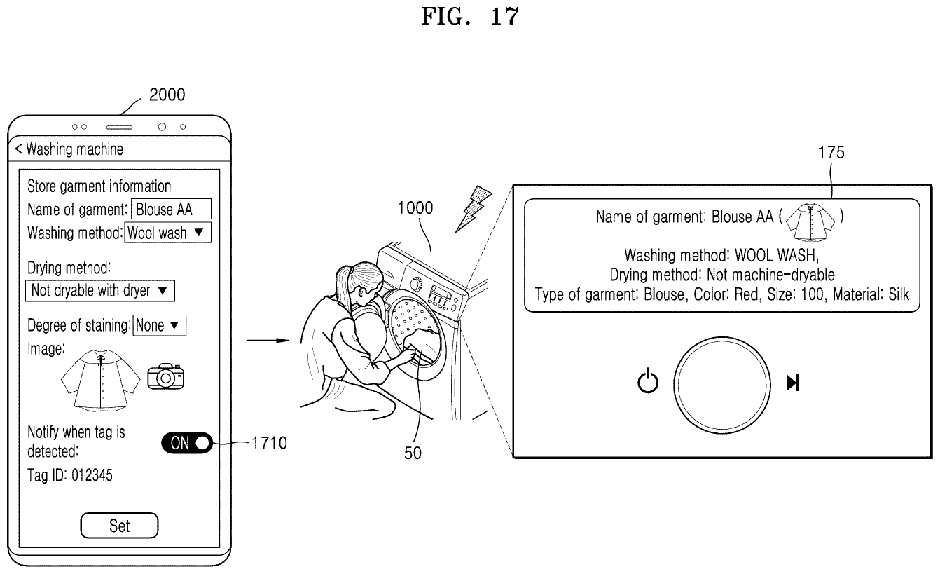

FIG. 17 illustrates a method, performed by the garment treatment device 1000, of providing a notification for a garment for which a notification is set, according to an embodiment of the disclosure.

Referring to FIG. 17, as a garment for which a notification is set is detected, the garment treatment device 1000 may output a notification. As the tag ID of the garment 50 is detected, the garment treatment device 1000 may output a notification that is set in correspondence to the tag ID.

A notification may be set in correspondence to an important garment. For example, as illustrated in FIG. 17, the user device 2000 may display a user interface 1710 for setting a notification to be output when the garment is detected.

Based on receiving a user input for setting a notification to be when the garment is detected, the user device 2000 may store a notification setting in correspondence to the tag ID of the garment 50. In addition, the user device 2000 may transmit notification setting information corresponding to the tag ID to the garment treatment device 1000 through a server. The garment treatment device 1000 may store a notification setting in correspondence to the tag ID.

As the garment 50 approaches the garment treatment device 1000 that is powered on, the garment treatment device 1000 may obtain the tag information of the garment 50. For example, as the garment 50 is loaded into the drum, the garment treatment device 1000 may obtain RFID tag information on the garment 50 through an RFID reader.

In addition, as a user input for powering on the garment treatment device 1000 is received, the garment treatment device 1000 may obtain tag information of at least one garment accommodated in the drum or the management chamber.

Based on determining that a notification is set in correspondence to the tag ID in the tag information, the garment treatment device 1000 may output a notification when the tag ID of the garment 50 is detected. The notification sound may include a predetermined single-tone buzzer, melody buzzer, or notification voice. The notification voice may be, for example, a voice signal indicating the name or type of the garment.

According to an embodiment of the disclosure, based on determining that a notification is set in correspondence to the tag ID, the garment treatment device 1000 may display garment information 175 of the garment 50. For example, the garment treatment device 1000 may display a garment name, a garment image, a washing method, or a drying method stored in correspondence to the tag ID.

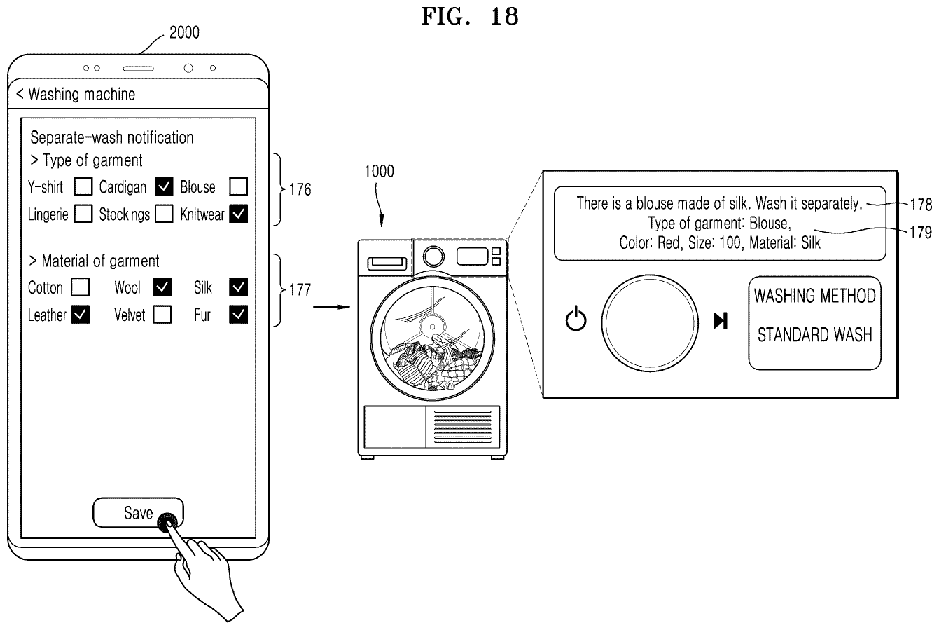

FIG. 18 illustrates a method, performed by the garment treatment device 1000, of outputting a separate-wash notification according to a garment category selected by a user, according to an embodiment of the disclosure.

Referring to FIG. 18, the user device 2000 may provide a user interface for setting a category of garments to be washed separately or dried separately.

For example, as illustrated in FIG. 18, the user device 2000 may display a user interface 176 for selecting a type of garment to be washed separately. In addition, for example, the user device 2000 may display a user interface 177 for selecting a material of garment to be washed separately.

Based on receiving a user input for selecting and storing a category of garments to be washed separately or dried separately, the user device 2000 may transmit, to the garment treatment device 1000 through the server, information about the category of garments to be washed separately or dried separately, which is selected by the user.

When a garment belonging to the set category is detected together with a garment belonging to another category, the garment treatment device 1000 may output guide information for guiding the user through washing separately or dry separately the garment belonging to the set category.

For example, based on determining that a garment made of cotton or synthetic fiber and a garment made of silk are to be washed together after garments made of silk are set as a category of garments to be washed separately, the garment treatment device 1000 may determine the garment made of silk, as a garment to be washed separately. Accordingly, the garment treatment device 1000 may output guide information 178 for guiding the user through washing separately the garment made of silk. In addition, the garment treatment device 1000 may display tag information 179 obtained from a tag of the garment to be washed separately. For example, the garment treatment device 1000 may display the garment type, color, size, or material of the garment to be washed separately.

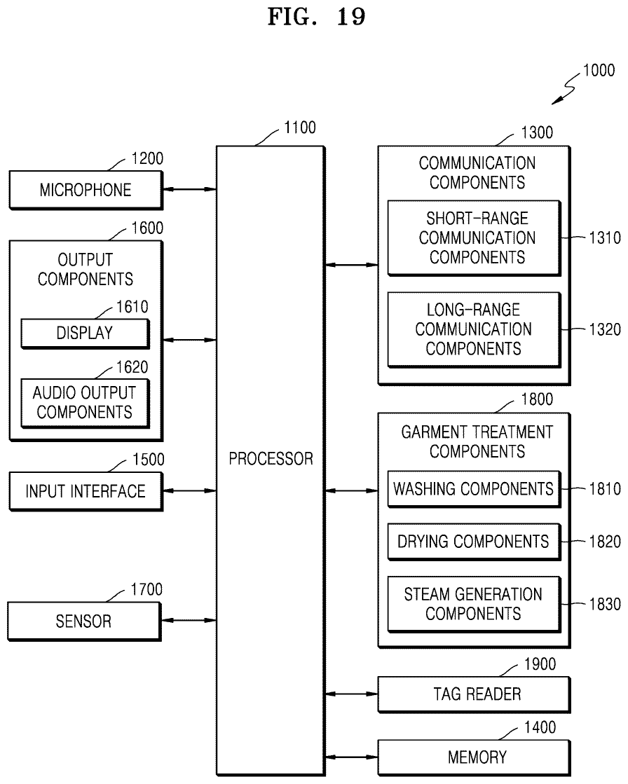

FIG. 19 illustrates a block diagram of the garment treatment device 1000 according to an embodiment of the disclosure.

Referring to FIG. 19, the garment treatment device 1000 may include the processor 1100, a microphone 1200, communication components 1300, the memory 1400, an input interface 1500, the output components 1600, a sensor 1700, the garment treatment components 1800, and the tag reader 1900.

All components illustrated in FIG. 19 are not essential components of the garment treatment device 1000. The garment treatment device 1000 may be implemented with more or fewer components than those illustrated in FIG. 19.

The same reference numerals are used for components that are the same as those illustrated in FIG. 2.

The garment treatment device 1000 may be a washing machine. In this case, the washing machine 1000 according to various embodiments of the disclosure may perform washing, rinse, dehydration, and drying cycles. The washing machine 1000 is an example of a garment treatment device, and the garment treatment device is a concept that encompasses devices for washing a garment (i.e., an article to be washed or an article to be dried), devices for drying a garment, and devices capable of washing and drying a garment.

The washing machine 1000 according to various embodiments of the disclosure may include a top-loading washing machine 1000 in which an inlet for loading or unloading laundry is provided to face upward, or a front-loading washing machine 1000 in which an inlet for loading or unloading laundry is provided to face the front. The washing machine 1000 according to various embodiments of the disclosure may include a washing machine 1000 with a loading method other than those of the top-loading washing machine 1000 and the front-loading washing machine 1000.

The top-loading washing machine 1000 may wash laundry by using a water current generated by a rotating body such as a pulsator. The front-loading washing machine 1000 may wash laundry by rotating a drum to repeatedly raise and fall the laundry. The front-loading washing machine 1000 may include a drying-and-washing machine 1000 capable of drying laundry accommodated in the drum. The drying-and-washing machine 1000 may include a hot-air supply device for supplying high-temperature air into the drum and a condensation device for removing moisture from air discharged from the drum. For example, the drying-and-washing machine 1000 may include a heat pump device. The washing machine 1000 according to various embodiments of the disclosure may include a washing machine 1000 with a washing method other than the washing methods described above.

The washing machine 1000 according to various embodiments of the disclosure may include a housing for accommodating various components therein. The housing may be provided in the form of a box with a laundry inlet formed on one side.

The washing machine 1000 may include a door for opening and closing the laundry inlet. The door may be mounted on the housing to be rotatable by a hinge. At least a portion of the door may be transparent or translucent such that the inside of the housing is visible.

The washing machine 1000 may include a tub provided inside the housing to store water. The tub may be provided in a substantially cylindrical shape with a tub opening formed on one side, and may be arranged inside the housing such that the tub opening is arranged to correspond to the laundry inlet.

The tub may be connected to the housing by a damper. The damper may absorb vibration that occurs when the drum rotates, to attenuate the vibration transmitted to the housing.

The washing machine 1000 may include a drum provided to accommodate laundry.

The drum may be arranged inside the tub such that a drum opening provided on one side corresponds to the laundry inlet and the tub opening. Laundry may sequentially pass through the laundry inlet, the tub opening, and the drum opening to be accommodated in or unloaded from the drum.

The drum may rotate inside the tub to perform each operation according to washing, rinse, and/or dehydration cycles. A plurality of holes may be formed on a cylindrical wall of the drum such that water stored in the tub may flow into or out of the drum.

The processor 1100 controls the overall operation of the garment treatment device 1000. The processor 1100 may execute a program stored in the memory 1400 to control the components of the garment treatment device 1000.

The processor 1100 may include a separate neural processing unit (NPU) configured to perform an operation of a machine learning model. In addition, the processor 1100 may include a central processing unit (CPU), a graphics processing unit (GPU), and the like.

The memory 1400 stores various pieces of information, data, instructions, programs, and the like necessary for an operation of the garment treatment device 1000. The memory 1400 may include at least one of volatile memory or non-volatile memory, or a combination thereof. The memory 1400 may include at least one of a flash memory-type storage medium, a hard disk-type storage medium, a multimedia card micro-type storage medium, card-type memory (e.g., SD or XD memory), random-access memory (RAM), static RAM (SRAM), read-only memory (ROM), electrically erasable programmable ROM (EEPROM), programmable ROM (PROM), magnetic memory, a magnetic disc, or an optical disc. In addition, the garment treatment device 1000 may operate a web storage or cloud server (not shown) that performs a storage function on the Internet.

At least one processor 1100 and at least one memory 1400 may be included in one control unit. For example, the at least one processor 1100 and the at least one memory 1400 may be included in one microcontroller unit (MCU).

The garment treatment components 1800 may include washing components 1810, drying components 1820, and steam generation components 1830.

The washing components 1810 may include a driving device configured to rotate the drum. The driving device may include a driving motor and a rotating shaft for transmitting a driving force generated by the driving motor to the drum. The rotating shaft may penetrate the tub to be connected to the drum.

The driving device may rotate the drum forward or backward to perform each operation according to washing, rinse, and/or dehydration cycles, or a drying cycle.

The washing components 1810 may include a water supply device configured to supply water to the tub. The water supply device may include a water supply pipe and a water supply valve provided in the water supply pipe. The water supply pipe may be connected to an external water supply source. The water supply pipe may extend from the external water source to a detergent supply device and/or the tub. Water may be supplied to the tub through the detergent supply device. Water may be supplied to the tub without going through the detergent supply device.

The water supply valve may open or close the water supply pipe in response to an electrical signal from a control unit. The water supply valve may allow or block water from being supplied to the tub from the external water source. The water supply valve may include, for example, a solenoid valve that is opened and closed in response to an electrical signal.

The washing components 1810 may include a detergent supply device configured to supply a detergent to the tub. The detergent supply device may include a manual detergent supply device that requires the user to input a detergent to be used in each washing process, and an automatic detergent supply device that stores a large amount of detergent and automatically inputs a predetermined amount of detergent in a washing process. The detergent supply device may include a detergent supply device for storing a detergent. The detergent supply device may be configured to supply a detergent into the tub in a water supply process. Water supplied through the water supply pipe may be mixed with a detergent via the detergent supply device. The water mixed with the detergent may be supplied into the tub. The term ‘detergent’ encompasses pre-wash detergents, main wash detergents, fabric softeners, bleaching agents, and the like, and the detergent supply device may be divided into a pre-wash detergent storage area, a main wash detergent storage area, a fabric softener storage area, and a bleaching agent storage area.

The washing components 1810 may include a drainage device configured to discharge water accommodated in the tub to the outside. The drainage device may include a drain pipe extending from the bottom of the tub to the outside of the housing, a drain valve provided on the drain pipe to open and close the drain pipe, and a pump provided on the drain pipe. The pump may pump water from the drain pipe to the outside of the housing.

The drying components 1820 may include at least one of a heat pump configured to remove moisture from laundry by circulating a refrigerant, or a heater configured to remove moisture from laundry by heating air. In addition, the drying components 1820 may include a blowing motor and a blowing fan.

The steam generation components 1830 may generate steam by heating water. The steam generated by the steam generation components may be sprayed into a management chamber inside the garment management device by blowing components.

The garment treatment device 1000 may include the control panel 1510 (see FIG. 1) arranged on one side of the housing. The control panel 1510 may provide a user interface for interaction between a user and the garment treatment device 1000. The user interface may include at least one input interface 1500 and at least one output components 1600.

The at least one input interface 1500 may convert sensory information received from the user into an electrical signal. The input interface 1500 may receive a user input for controlling the garment treatment device 1000.

The input interface 1500 may include a user input device including a touch panel for detecting a touch of the user, a button for receiving a push operation of the user, a wheel for receiving a rotation operations of the user, a keyboard, a dome switch, and the like, but is not limited thereto.

In addition, the input interface 1500 may include a motion sensor (not shown). For example, the motion sensor (not shown) may detect a motion of the user and receive the detected motion as a user input.

The input interface 1500 receives a user input and transmits it to the processor 1100.

The at least one input interface 1500 may include a power button, an operation button, a course selection dial (or a course selection button), and washing/rinse/dehydration/dry setting buttons. The at least one input interface 1500 may include, for example, a tact switch, a push switch, a slide switch, a toggle switch, a microswitch, a touch switch, a touch pad, a touch screen, a jog dial, and/or the microphone 1200.

The at least one output components 1600 may visually or audibly deliver information related to an operation of the garment treatment device 1000 to the user.

For example, the at least one output components 1600 may deliver, to the user, information related to a washing course, an operation time of the garment treatment device 1000, and washing settings/rinse settings/dehydration settings/dry settings. Information about an operation of the garment treatment device 1000 may be output through a screen, an indicator, a sound, or the like. The at least one output components 1600 may include a display 1610 and audio output components 1620.

The display 1610 may output image data processed by an image processor (not shown) through a display panel (not shown) under control of the processor 1100. The display panel (not shown) may include at least one of a liquid-crystal display, a thin-film-transistor liquid-crystal display, an organic light-emitting diode, a flexible display, a three-dimensional (3D) display, or an electrophoretic display.

The audio output components 1620 may output an audio signal to the outside of the garment treatment device 1000. The audio output components 1620 may include, for example, a speaker or a receiver. The speaker may be used for general purposes, such as reproducing multimedia or record.

The microphone 1200 may receive a voice command or a voice request from the user. Accordingly, the processor 1100 may control an operation corresponding to the voice command or voice request to be performed. In addition, the microphone 1200 may receive an audio around the garment treatment device 1000.

The communication components 1300 may transmit and receive information to and from an external device (not shown) or the server 3000 according to a protocol under control of the processor 1100. The communication components 1300 may include at least one communication components configured to transmit and receive data to and from the external device (not shown) or the server 3000, and at least one port.

In addition, the communication components 1300 may perform communication with an external device through at least one wired or wireless communication network. The communication components 1300 may include at least one of a short-range wireless communication components 1310 or a long-range communication components 1320, or a combination thereof. The communication components 1300 may include at least one antenna for wireless communication with other devices.

The communication components 1300 may transmit or receive data to or from an external device (e.g., a server, a user device, and/or a home appliance). For example, the communication components 1300 may establish a communication with the server 3000 and/or the user device 2000 and/or other home appliances, and transmit and receive various pieces of data.

To this end, the communication components 1300 may support establishment of a direct (e.g., wired) communication channel or a wireless communication channel between external devices, and communication through the established communication channel. According to an embodiment of the disclosure, the communication components 1300 may include a wireless communication components (e.g., a cellular communication components, a short-range wireless communication components, or a global navigation satellite system (GNSS) communication components) or a wired communication components (e.g., a local area network (LAN) communication components or a power line communication components). The communication components 1300 may communicate with an external device through a first network (e.g., a short-range communication network such as Bluetooth, Wi-Fi Direct, or Infrared Data Association (IrDA)) or a second network (e.g., a long-range communication network such as a legacy cellular network, a 5G network, a next-generation communication network, the Internet, or a computer network (e.g., a local area network (LAN) or a wide area network (WAN)). Various types of communication components s may be integrated into one component (e.g., a single chip) or implemented by a plurality of separate components (e.g., a plurality of chips).

The short-range wireless communication components 1310 may include, but is not limited to, a Bluetooth communication components, a Bluetooth Low Energy (BLE) communication components, an NFC module, a wireless LAN (Wi-Fi) communication components, a Zigbee communication components, an IrDA communication components, a Wi-Fi Direct (WFD) communication components, an ultra-wideband (UWB) communication components, an Ant+ communication components, a microwave (uWave) communication components, and the like.

The long-range communication components 1320 may include a communication components for performing various types of long-range communication, and may include a mobile communication unit. The mobile communication unit transmits and receives wireless signals to and from at least one of a base station, an external terminal, or the server 3000, on a mobile communication network.

In an embodiment of the disclosure, the communication components 1300 may communicate with an external device such as the server 3000, the user device 2000, and other home appliances, through a nearby access point (AP). The AP may connect a LAN to which the garment treatment device 1000 or a user device is connected, to a WAN to which the server 3000 is connected. The garment treatment device 1000 or the user device 2000 may be connected to the server 3000 through the WAN.

The control unit may control various components of the garment treatment device 1000. The control unit may be referred to as an MCU. The control unit may control various components of the garment treatment device 1000 to perform at least one of a water supply cycle, a washing cycle, a rinse cycle, and/or a dehydration cycle, according to a user input. For example, the control unit may control the driving motor of the washing components 1810 to adjust the rotational speed of the drum, or control the water supply valve of the water supply device of the washing components 1810 to supply water to the tub.

The control unit may include hardware such as the processor 1100 or the memory 1400, and software such as a control program. For example, the control unit may include at least one memory storing an algorithm for controlling operations of components within the garment treatment device 1000 the above-described operations, and data in the form of a program, and at least one processor configured to perform the above-described operations by using the data stored in the at least one memory. Each of the memory and the processor may be implemented as a separate chip. The processor may include one or more processor chips, or may include one or more processing cores. The memory may include one or more memory chips, or may include one or more memory blocks. In addition, the memory and the processor may be implemented as a single chip.

The sensor 1700 may include, but is not limited to, a temperature sensor, a humidity sensor, and a water level sensor.

The tag reader 1900 may include, but is not limited to, an RFID reader, an NFC reader, a QR code reader, or a barcode reader.

At least one processor 1100 may obtain garment information of a plurality of garments accommodated in the garment treatment device 1000, through the tag reader 1900.

The at least one processor 1100 may determine whether there is a garment that needs to be separated from the other garments among the plurality of garments, based on the obtained garment information.

Based on determining that there is a garment that needs to be separated from the other garments, the at least one processor 1100 may output, through the output components 1600, guide information for guiding the user through separating the garment that needs to be separated from the other garments, along with identification information of the garment that needs to be separated.

The at least one processor 1100 may control the garment treatment components 1800 according to a user input in response to the guide information, to wash or dry the other garments with or without the garment that needs to be separated.

Based on determining that there is a garment that needs to be separated from the other garments, the at least one processor 1100 may display, through the display 1610, an identification image of the garment that needs to be separated.

Based on information about a degree of staining, which is included in the garment information of the plurality of garments, the at least one processor 1100 may determine a garment that is likely to stain surrounding garments from among the plurality of garments, as a garment that needs to be separated from the other garments.

Based on receiving, through the input interface 1500, a user input for starting washing, which is input after the garment that needs to be separated is unloaded according to the guide information, the at least one processor 1100 may control the washing components 1810 to wash the other garments.

Based on information about whether the plurality of garments are machine-dryable, which is included in the garment information of the plurality of garments, the at least one processor 1100 may determine a garment that is not machine-dryable from among the plurality of garments, as a garment that needs to be separated from the other garments.

Based on receiving, through the input interface 1500, a user input for starting drying, which is input after the garment that needs to be separated is unloaded according to the guide information, the at least one processor 1100 may control the drying components 1820 to dry the other garments.

The at least one processor 1100 may detect tag IDs of the plurality of garments through the tag reader 1900, and obtain the garment information corresponding to the tag IDs.

The garment information corresponding to the tag IDs may be garment information based on a user input received through the user device 2000.

The at least one processor 1100 may rotate the drum to move the position of the garment that needs to be separated, to the top of the plurality of garments, such that the garment that needs to be separated among the plurality of garments is visible in the drum.

The at least one processor 1100 may output, through the output components 1600, guide information for guiding the user through a washing method for the other garments, along with a washing method for the garment that needs to be separated.

The garment information of the plurality of garments may include notification setting information about whether to output a notification that a garment has been loaded into the garment treatment device 1000.

As a tag ID of a garment for which a notification is set to be output among the plurality of garments is detected, the at least one processor 1100 may output a notification that the garment has been loaded into the garment treatment device 1000, through the output components 1600.

The at least one processor 1100 may display garment information of the garment for which a notification is set to be output, along with outputting the notification.

When washing or drying is performed more than a predetermined number of times for the garment that needs to be separated, as the garment that needs to be separated is washed or dried without being separated after the guide information is output, the at least one processor 1100 may change a washing or a drying method for the garment that needs to be separated.

A machine-readable storage medium may be provided in the form of a non-transitory storage medium. Here, the term ‘non-transitory storage medium’ refers to a tangible device and does not include a signal (e.g., an electromagnetic wave), and the term ‘non-transitory storage medium’ does not distinguish between a case where data is stored in a storage medium semi-permanently and a case where data is stored temporarily. For example, the ‘non-transitory storage medium’ may include a buffer in which data is temporarily stored.

According to an embodiment of the disclosure, methods according to various embodiments disclosed herein may be included in a computer program product and then provided. The computer program product may be traded as commodities between sellers and buyers. The computer program product may be distributed in the form of a machine-readable storage medium (e.g., a compact disc ROM (CD-ROM)), or may be distributed online (e.g., downloaded or uploaded) through an application store or directly between two user devices (e.g., smart phones). In a case of online distribution, at least a portion of the computer program product (e.g., a downloadable app) may be temporarily stored in a machine-readable storage medium such as a manufacturer's server, an application store's server, or a memory of a relay server.

Although the present disclosure has been described with various embodiments, various changes and modifications may be suggested to one skilled in the art. It is intended that the present disclosure encompass such changes and modifications as fall within the scope of the appended claims.

What is claimed is:

1. A garment treatment device comprising:
garment treatment components;
a tag reader;
output components;
at least one memory storing one or more instructions; and
at least one processor configured to execute the one or more instructions stored in the memory to cause the garment treatment device to:
obtain garment information of a plurality of garments accommodated in the garment treatment device through the tag reader,
determine, based on the obtained garment information, whether there is a garment that needs to be separated from other garments among the plurality of garments,
based on determining that there is the garment that needs to be separated from the other garments, output, through the output components, guide information for guiding a user through separating the garment that needs to be separated from the other garments, along with identification information of the garment that needs to be separated, and
control the garment treatment components to wash or dry the other garments with or without the garment that needs to be separated according to a user input received in response to the guide information.

2. The garment treatment device of claim 1, wherein:
the output components comprises a display, and
based on determining that there is the garment that needs to be separated from the other garments, the at least one processor is further configured to display, through the display, an identification image of the garment that needs to be separated.

3. The garment treatment device of claim 1, wherein:
the garment treatment components comprises washing components, and
the at least one processor is further configured to:
based on information about a degree of staining, which is included in the garment information of the plurality of garments, determine a garment that is likely to stain surrounding garments from among the plurality of garments, as the garment that needs to be separated from the other garments, and
based on receiving a user input to start washing, which is input after the garment that needs to be separated is unloaded according to the guide information, control the washing components to wash the other garments.

4. The garment treatment device of claim 1, wherein:
the garment treatment components comprises drying components, and
the at least one processor is further configured to:
based on information about whether the plurality of garments are machine-dryable, which is included in the garment information of the plurality of garments, determine a garment that is not machine-dryable from among the plurality of garments, as the garment that needs to be separated from the other garments, and
based on receiving a user input to start drying, which is input after the garment that needs to be separated is unloaded according to the guide information, control the drying components to dry the other garments.

5. The garment treatment device of claim 1, wherein:
the at least one processor is further configured to:
detect tag identifiers (IDs) of the plurality of garments through the tag reader, and
obtain the garment information corresponding to the tag IDs, and
the garment information corresponding to the tag IDs is garment information based on a user input received through a user device.

6. The garment treatment device of claim 1, wherein the at least one processor is further configured to rotate a drum to move a position of the garment that needs to be separated to a top of the plurality of garments such that the garment that needs to be separated among the plurality of garments is visible in the drum.

7. The garment treatment device of claim 1, wherein the at least one processor is further configured to output, through the output components, guide information for guiding the user through a washing method for the other garments, along with a washing method for the garment that needs to be separated.

8. The garment treatment device of claim 1, wherein:
the garment information of the plurality of garments comprises notification setting information about whether to output a notification that a garment has been loaded into the garment treatment device, and
the at least one processor is further configured to, as a tag ID of a garment for which a notification is set to be output among the plurality of garments is detected based on the notification setting information, output the notification that the garment with the tag ID has been loaded into the garment treatment device through the output components.

9. The garment treatment device of claim 8, wherein the at least one processor is further configured to display garment information of the garment for which the notification is set to be output along with outputting the notification.

10. The garment treatment device of claim 1, wherein the at least one processor is further configured to, when washing or drying is performed more than a predetermined number of times for the garment that needs to be separated, as the garment that needs to be separated is washed or dried without being separated after the guide information is output, change a washing method or a drying method for the garment that needs to be separated.

11. A method of controlling a garment treatment device, the method comprising:
obtaining garment information of a plurality of garments accommodated in the garment treatment device through a tag reader;
determining, based on the obtained garment information, whether there is a garment that needs to be separated from other garments among the plurality of garments;
based on determining that there is the garment that needs to be separated from the other garments, outputting guide information for guiding a user through separating the garment that needs to be separated from the other garments along with identification information of the garment that needs to be separated; and
washing or drying the other garments with or without the garment that needs to be separated according to a user input received in response to the guide information.

12. The method of claim 11, wherein the outputting of the guide information for guiding the user through separating the garment that needs to be separated, from the other garments, along with the identification information of the garment that needs to be separated comprises displaying an identification image of the garment that needs to be separated.

13. The method of claim 11, wherein:
the determining, based on the obtained garment information, of whether there is the garment that needs to be separated from the other garments among the plurality of garments comprises, based on information about a degree of staining, which is included in the garment information of the plurality of garments, determining a garment that is likely to stain surrounding garments from among the plurality of garments, as the garment that needs to be separated from the other garments, and
the washing or drying of the other garments with or without the garment that needs to be separated, according to the user input in response to the guide information comprises, based on receiving a user input for starting washing, which is input after the garment that needs to be separated is unloaded according to the guide information, washing the other garments.

14. The method of claim 11, wherein the determining, based on the obtained garment information, of whether there is the garment that needs to be separated from the other garments among the plurality of garments comprises, based on information about whether the plurality of garments are machine-dryable, which is included in the garment information of the plurality of garments, determining a garment that is not machine-dryable from among the plurality of garments, as the garment that needs to be separated from the other garments, and
the washing or drying of the other garments with or without the garment that needs to be separated, according to the user input in response to the guide information comprises, based on receiving a user input for starting drying, which is input after the garment that needs to be separated is unloaded according to the guide information, drying the other garments.

15. The method of claim 11, wherein:
the obtaining of the garment information of the plurality of garments accommodated in the garment treatment device through the tag reader comprises detecting tag identifiers (IDs) of the plurality of garments through the tag reader, and obtaining the garment information corresponding to the tag IDs, and
the garment information corresponding to the tag IDs is garment information based on a user input received through a user device.

16. The method of claim 11, further comprising rotating a drum to move a position of the garment that needs to be separated to a top of the plurality of garments such that the garment that needs to be separated among the plurality of garments is visible in the drum.

17. The method of claim 11, further comprising outputting guide information for guiding the user through a washing method for the other garments, along with a washing method for the garment that needs to be separated.

18. The method of claim 11, wherein:
the garment information of the plurality of garments comprises notification setting information about whether to output a notification that a garment has been loaded into the garment treatment device, and
the method further comprises, as a tag ID of a garment for which a notification is set to be output among the plurality of garments is detected based on the notification setting information, outputting the notification that the garment with the tag ID has been loaded into the garment treatment device.

19. The method of claim 18, further comprising displaying garment information of the garment for which the notification is set to be output, along with outputting the notification.

20. The method of claim 11, further comprising, when washing or drying is performed more than a predetermined number of times for the garment that needs to be separated, as the garment that needs to be separated is washed or dried without being separated after the guide information is output, changing a washing method or a drying method for the garment that needs to be separated.
